(19) United States
(12) Patent Application Publication
(10) Pub. No.: US 2026/0105890 A1
(43) Pub. Date: Apr. 16, 2026

(54) DISPLAY DEVICE AND ELECTRONIC DEVICE

(71) Applicant: Samsung Display Co., LTD., Yongin-si (KR)

(72) Inventors: JUNHYUN PARK, Yongin-si (KR); HWA-RANG LEE, Yongin-si (KR); NAHYEON CHA, Yongin-si (KR)

(21) Appl. No.: 19/347,857

(22) Filed: Oct. 2, 2025

(30) Foreign Application Priority Data
Oct. 14, 2024 (KR) 10-2024-0139133

(51) Int. Cl. G09G 3/3233; G09G 3/20

(52) U.S. Cl. CPC G09G 3/3233; G09G 3/2092; G09G 2300/0819; G09G 2300/0852; G09G 2300/0861; G09G 2310/0286; G09G 2310/08

(57) ABSTRACT

A display device includes a display panel including a pixel, a gate emission driver which outputs a gate signal and an emission signal to the pixel. The gate emission driver includes a control gate signal generator which generates a control gate signal and a write gate signal generator which generates a write gate signal. The pixel includes a driving transistor, a write transistor which applies the data voltage to the driving transistor in response to the write gate signal, an initialization transistor which applies a reference voltage to the driving transistor in response to the control gate signal and a light emitting element. The write gate signal generator generates the write gate signal based on a carry clock signal and a first clock signal. The control gate signal generator generates the control gate signal based on the carry clock signal.

This application claims priority to Korean Patent Application No. 10-2024-0139133, filed on October 14, 2024, and all the benefits accruing therefrom under 35 U.S.C. §119, the content of which in its entirety is herein incorporated by reference.

### BACKGROUND

### 1. Field

Embodiments of the invention relate to a display device and an electronic device. More particularly, embodiments of the invention relate to a display device and an electronic device with improved integration.

### 2. Description of the Related Art

Generally, a display device includes a display panel and a display panel driver. The display panel includes a plurality of gate lines, a plurality of data lines, a plurality of emission lines and a plurality of pixels. The display panel driver includes a gate driver providing a gate signal to the gate lines, a data driver providing a data voltage to the data lines and a driving controller controlling the gate driver, the data driver and the emission driver.

### SUMMARY

Generally, a display device may include a plurality of clock lines connected to the gate driver and the emission driver. When the number of the clock lines are increased, an integration of the display device may be reduced.

Embodiments of the invention provide a display device with improved integration.

Embodiments of the invention provide an electronic device with improved integration.

According to embodiments, a display device includes a display panel including a pixel, a gate emission driver which outputs a gate signal and an emission signal to the pixel, a data driver which applies a data voltage to the display panel and a driving controller which controls the gate emission driver and the data driver. The gate emission driver includes a control gate signal generator which generate a control gate signal and a write gate signal generator which generates a write gate signal. In such embodiments, the pixel includes a driving transistor which generates a driving current based on the data voltage, a write transistor which applies the data voltage to a control electrode of the driving transistor in response to the write gate signal, an initialization transistor which applies a reference voltage to the control electrode of the driving transistor in response to the control gate signal and a light emitting element which emits light based on the driving current. In such embodiments, the write gate signal generator generates the write gate signal based on a carry clock signal and a first clock signal, and the control gate signal generator generates the control gate signal based on the carry clock signal.

In an embodiment, the write gate signal generator may be connected to a carry clock line which transmits the carry clock signal. In such an embodiment, the control gate signal generator may be connected to the carry clock line.

In an embodiment, the write gate signal generator may generate the write gate signals based on the carry clock signal, the first clock signal and a second clock signal. In such an embodiment, the write gate signal generator may include a write gate signal controller which outputs a carry signal based on the carry clock signal, a first write gate signal outputter which outputs a first write gate signal based on the carry signal and the first clock signal and a second write gate signal outputter which outputs a second write gate signal based on the carry signal and a second clock signal.

In an embodiment, the display panel may include first to N-th pixel-rows which are sequentially arranged. In such an embodiment, the first write gate signal may be applied to the first pixel-row, and the second write gate signal may be applied to the second pixel-row.

In an embodiment, the control gate signal generator may output the control gate signal to the first pixel-row and the second pixel-row.

In an embodiment, a frame period in which the display panel is driven may include an address period and a self-scan period. In such an embodiment, in the address period, the data voltage may be applied to the pixel, and the pixel may emit light based on the data voltage. In such an embodiment, in the self-scan period, the pixel may emit light based on the data voltage of the address period. In the self-scan period, the carry clock signal may have direct current (DC) voltage.

In an embodiment, in the address period, the write gate signal may maintain an inactivation level, and the control gate signal may maintain an inactivation level.

In an embodiment, the pixel may include a first transistor including a control electrode connected to a first node, a first electrode connected to a second node and a second electrode connected to a third node, a second transistor which applies the data voltage to the first node in response to the write gate signal, a third transistor which applies the reference voltage to the first node in response to the control gate signal, a fourth transistor which applies a first power voltage to the second node in response to a second emission signal, a fifth transistor which connects the third node and a fourth node to each other in response to a first emission signal, a sixth transistor which applies an initialization voltage to the fourth node in response to an initialization gate signal, a first capacitor including a first electrode connected to the first node and a second electrode connected to the third node and a light emitting element including a first electrode connected to the fourth node and a second electrode which receives a second power voltage. In such an embodiment, the first transistor may be the driving transistor, the second transistor may be the write transistor, and the third transistor may be the initialization transistor.

In an embodiment, the gate emission driver may further include a first emission control signal generator which generates the first emission signal, a second emission control signal generator which generates the second emission signal, and an initialization gate signal generator which generates the initialization gate signal. In such an embodiment, the first emission control signal generator may generate the first emission signal based on a third clock signal and a fourth clock signal. In such an embodiment, the second emission control signal generator may generate the second emission signal based on the third clock signal and the fourth clock signal. In such an embodiment, the initialization gate signal generator may generate the initialization gate signal based on the third clock signal and the fourth clock signal.

In an embodiment, the second emission control signal generator may include second-first to second-K-th emission control signal sub-generators. In such an embodiment, the initialization gate signal generator may include first to K-th initialization gate signal sub-generators. In such an embodiment, the second-first to second-K-th emission control signal sub-generators and first to K-th initialization gate signal sub-generators may be arranged alternately with each other.

In an embodiment, wherein a write gate line, which transmits the write gate signal, may extend in a first direction. In such an embodiment, the first initialization gate signal sub-generator may be spaced apart from the second-first emission control signal sub-generator in a second direction different from the first direction. In such an embodiment, the second-second emission control signal sub-generator may be spaced apart from the first initialization gate signal sub-generator in a second direction. In such an embodiment, the second initialization gate signal sub-generator may be spaced apart from the second-second emission control signal sub-generator in the second direction.

In an embodiment, the first emission control signal generator may include first to K-th emission control signal sub-generators. In such an embodiment, the first to K-th emission control signal sub-generators may be sequentially arranged in the second direction.

In an embodiment, the pixel may further include a second capacitor. In such an embodiment, the first transistor further may include a second control electrode connected to the third node. In such an embodiment, the second transistor may include a control electrode which receives the write gate signal, a first electrode which receives the data voltage and a second electrode connected to the first node. In such an embodiment, the third transistor may include a control electrode which receives the control gate signal, a first electrode which receives the reference voltage and a second electrode connected to the first node. In such an embodiment, the fourth transistor may include a control electrode which receives the second emission signal, a first electrode which receives the first power voltage and a second electrode connected to the second node. In such an embodiment, the fifth transistor may include a control electrode which receives the first emission signal, a first electrode connected to the third node and a second electrode connected to the fourth node. In such an embodiment, the sixth transistor may include a control electrode which receives the initialization gate signal, a first electrode which receives the initialization voltage and a second electrode connected to the fourth node. In such an embodiment, the second capacitor may include a first electrode which receives the first power voltage and a second electrode connected to the third node.

According to embodiments, a display device includes a display panel including a pixel, a gate emission driver which outputs a gate signal and an emission signal to the pixel, a data driver which applies a data voltage to the display panel and a driving controller which controls the gate emission driver and the data driver. In such embodiments, the pixel includes a first transistor including a control electrode connected to a first node, a first electrode connected to a second node and a second electrode connected to a third node, a second transistor which applies the data voltage to the first node in response to a write gate signal, a third transistor which applies a reference voltage to the first node in response to a control gate signal, a fourth transistor which applies a first power voltage to the second node in response to a second emission signal, a fifth transistor which connects the third node and a fourth node to each other in response to a first emission signal, a sixth transistor which applies an initialization voltage to the fourth node in response to an initialization gate signal, a first capacitor including a first electrode connected to the first node and a second electrode connected to the third node and a light emitting element including a first electrode connected to the fourth node and a second electrode which receives a second power voltage. In such embodiments, the gate emission driver includes a first emission control signal generator which generates the first emission signal based on a first clock signal and a second clock signal, a control gate signal generator which generates the control gate signal based on the first clock signal and the second clock signal, a second emission control signal generator which generates the second emission signal based on a first clock signal and a second clock signal and an initialization gate signal generator which generates the initialization gate signal based on the first clock signal and the second clock signal.

In an embodiment, a write gate line which transmits the write gate signal may extend in a first direction. In such an embodiment, the initialization gate signal generator may be spaced apart from the second emission control signal generator in a second direction different from the first direction. In such an embodiment, the control gate signal generator may be spaced apart from the first emission control signal generator in the second direction.

In an embodiment, the display panel may include first to N-th pixel-rows which are sequentially located. In such an embodiment, the write gate signal may include first to N-th write gate signals. In such an embodiment, the first write gate signal may be applied to the first pixel-row, the second write gate signal may be applied to the second pixel-row, the third write gate signal may be applied to the third pixel-row, and the fourth write gate signal may be applied to the fourth pixel-row. In such an embodiment, a timing of the first emission signal applied to the first pixel-row may be consistent with a timing of the first emission signal applied to the second pixel-row. In such an embodiment, a timing of the first emission signal applied to the third pixel-row may be consistent with a timing of the first emission signal applied to the fourth pixel-row. In such an embodiment, the timing of the first emission signal applied to the first pixel-row may be inconsistent with the timing of the first emission signal applied to the third pixel-row.

In an embodiment, the display panel may include first to N-th pixel-rows which are sequentially located. In such an embodiment, the write gate signal may include first to N-th write gate signals. In such an embodiment, the first signal may include first-first to fisrt-K-th emission signals. In such an embodiment, the second signal may include first-first to second-K-th emission signals. In such an embodiment, the control gate signal may include first to K-th control gate signals. In such an embodiment, the initialization gate signal may include first to K-th initialization gate signals. In such an embodiment, the first write gate signal may be applied to the first pixel-row, and the second write gate signal is applied to the second pixel-row. In such an embodiment, the first-first emission signal, the second-first emission signal, the first control gate signal and the first initialization gate signal may be applied to the first pixel-row and the second pixel-row.

According to embodiments, an electronic device includes a display panel including a pixel, a gate emission driver which outputs a gate signal and an emission signal to the pixel, a data driver which applies a data voltage to the display panel, a driving controller which controls the gate emission driver and the data driver based on an input control signal and a processor which outputs the input control signal to the driving controller. In such embodiments, the gate emission driver includes a control gate signal generator which generates a control gate signal and a write gate signal generator which generates a write gate signal. In such embodiments, the pixel includes a driving transistor which generates a driving current based on the data voltage, a write transistor which applies the data voltage to a control electrode of the driving transistor in response to the write gate signal, an initialization transistor which applies a reference voltage to the control electrode of the driving transistor in response to the control gate signal and a light emitting element which emits light based on the driving current. In such embodiments, the write gate signal generator generates the write gate signal based on a carry clock signal and a first clock signal, and the control gate signal generator generates the control gate signal based on the carry clock signal.

In an embodiment, the write gate signal generator may be connected to a carry clock line which transmits the carry clock signal. In such an embodiment, the control gate signal generator may be connected to the carry clock line.

In an embodiment, the write gate signal generator may generate the write gate signals based on the carry clock signal, the first clock signal and a second clock signal. In such an embodiment, the write gate signal generator may include a write gate signal controller which outputs a carry signal based on the carry clock signal, a first write gate signal outputter which outputs a first write gate signal based on the carry signal and the first clock signal and a second write gate signal outputter which outputs a second write gate signal based on the carry signal and a second clock signal.

In embodiments of the invention, as described above, the gate emission driver included in the display device and the electronic device may include the write gate signal generator, the control gate signal generator, the initialization gate signal generator, the first emission control signal generator and the second emission control signal generator. In such an embodiment, at least two generators selected from the write gate signal generator, the control gate signal generator, the initialization gate signal generator, the first emission control signal generator and the second emission control signal generator may be connected to a same clock line. Accordingly, an integration of the gate emission driver may be improved. Additionally, an integration of the display device and the electronic device may be improved.

In such embodiments, a driving frequency of the display panel included in the display device and the electronic device may be variable, such that a power consumption of the display device may be reduced.

### BRIEF DESCRIPTION OF THE DRAWINGS

Illustrative, non-limiting embodiments will be more clearly understood from the following detailed description in conjunction with the accompanying drawings.

FIG. 1 is a block diagram illustrating a display device according to embodiments of the invention.

FIG. 2 is a circuit diagram illustrating an example of a pixel included in a display device of FIG. 1.

FIG. 3 is a diagram illustrating an example of display region of a display panel included in a display device of FIG. 1.

FIG. 4 is a diagram illustrating an example of signals applied to a display region of FIG. 3.

FIG. 5 is a block diagram illustrating an example of stages included in a gate emission driver of FIG. 1.

FIG. 6 is a diagram illustrating an example of location of stage of FIG. 6.

FIG. 7 is a block diagram illustrating an example of a first stage included in stages of FIG. 6.

FIG. 8 is a block diagram illustrating an example of stages included in a gate emission driver of FIG. 1.

FIG. 9 is a diagram illustrating an example of location of stage of FIG. 8.

FIG. 10 is a block diagram illustrating an example of a first stage included in stages of FIG. 9.

FIG. 11 is a diagram illustrating frame periods in which a pixel of FIG. 2 is driven.

FIG. 12 is a signal timing diagram illustrating signals applied to a pixel of FIG. 2 in a first frame period of FIG. 11.

FIG. 13 is a table illustrating a driving clock signals of FIG. 7 and clock signals of FIG. 10 in a first frame period.

FIG. 14 is a signal timing diagram illustrating signals applied to a pixel of FIG. 2 in a second frame period of FIG. 11.

FIG. 15 is a table illustrating a driving clock signals of FIG. 7 and clock signals of FIG. in a second frame period.

FIG. 16 is a block diagram illustrating an example of stages included in a gate emission driver of FIG. 1.

FIG. 17 is a diagram illustrating an example of location of stage of FIG. 16.

FIG. 18 is a block diagram illustrating an example of a first stage included in stages of FIG. 17.

FIG. 19 is a block diagram illustrating an electronic device according to an embodiment of the invention.

FIG. 20 is a diagram illustrating an example in which the electronic device of FIG. 19 is implemented as a smart phone.

### DETAILED DESCRIPTION

The invention now will be described more fully hereinafter with reference to the accompanying drawings, in which various embodiments are shown. This invention may, however, be embodied in many different forms, and should not be construed as limited to the embodiments set forth herein. Rather, these embodiments are provided so that this disclosure will be thorough and complete, and will fully convey the scope of the invention to those skilled in the art. Like reference numerals refer to like elements throughout.

It will be understood that when an element is referred to as being “on” another element, it can be directly on the other element or intervening elements may be present therebetween. In contrast, when an element is referred to as being “directly on” another element, there are no intervening elements present.

It will be understood that, although the terms “first,” “second,” “third” etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, “a first element,” “component,” “region,” “layer” or “section” discussed below could be termed a second element, component, region, layer or section without departing from the teachings herein.

The terminology used herein is for the purpose of describing particular embodiments only and is not intended to be limiting. As used herein, "a", "an," "the," and “at least one” do not denote a limitation of quantity, and are intended to include both the singular and plural, unless the context clearly indicates otherwise. Thus, reference to “an” element in a claim followed by reference to “the” element is inclusive of one element and a plurality of the elements. For example, "an element" has the same meaning as “at least one element," unless the context clearly indicates otherwise. “At least one” is not to be construed as limiting “a” or “an.” “Or” means “and/or.” As used herein, the term “and/or” includes any and all combinations of one or more of the associated listed items. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Furthermore, relative terms, such as “lower” or “bottom” and “upper” or “top,” may be used herein to describe one element's relationship to another element as illustrated in the Figures. It will be understood that relative terms are intended to encompass different orientations of the device in addition to the orientation depicted in the Figures. For example, if the device in one of the figures is turned over, elements described as being on the “lower” side of other elements would then be oriented on “upper” sides of the other elements. The term “lower,” can therefore, encompasses both an orientation of “lower” and “upper,” depending on the particular orientation of the figure. Similarly, if the device in one of the figures is turned over, elements described as “below” or “beneath” other elements would then be oriented “above” the other elements. The terms “below” or “beneath” can, therefore, encompass both an orientation of above and below.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Embodiments are described herein with reference to schematic illustrations of idealized embodiments. As such, variations from the shapes of the illustrations as a result, for example, of manufacturing techniques and/or tolerances, are to be expected. Thus, embodiments described herein should not be construed as limited to the particular shapes of regions as illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the present claims.

Hereinafter, embodiments of the invention will be described in detail with reference to the accompanying drawings.

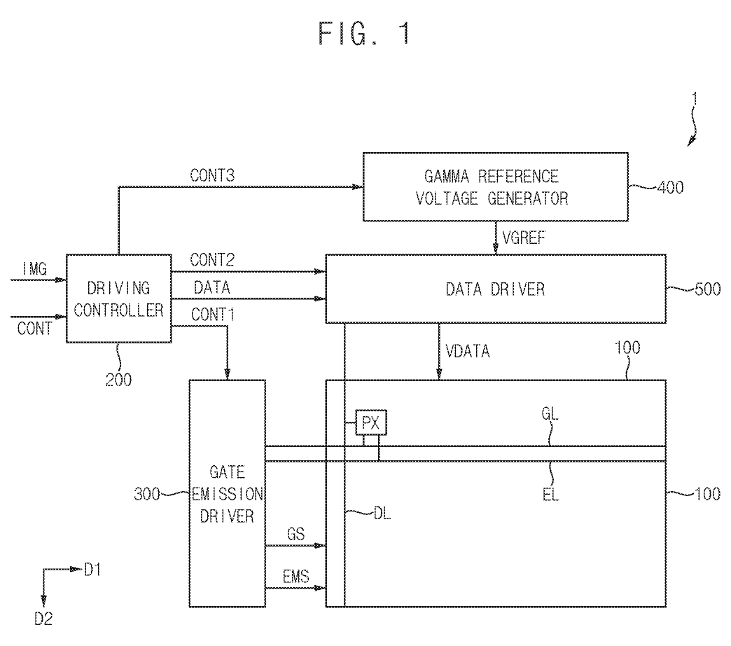

FIG. 1 is a block diagram illustrating a display device 1 according to embodiments of the invention.

Referring to FIG. 1, an embodiment of the display device 1 may include a display panel 100 and a display panel driver. The display panel driver may include a driving controller 200, a gate emission driver 300, a gamma reference voltage generator 400 and a data driver 500.

The display panel 100 may include (or be divided into) a display region, on which an image is displayed, and a peripheral region adjacent to the display region.

The display panel 100 may include a plurality of gate lines GL, plurality of emission lines EL, a plurality of data lines DL and a plurality of pixel circuits PX electrically connected to the gate lines GL, the emission lines EL and the data lines DL. The gate lines GL may extend in a first direction D1, the emission lines EL may extend in the first direction D1 and the data lines DL may extend in a second direction D2 crossing the first direction D1.

The driving controller 200 may receive input image data IMG and an input control signal CONT from an external apparatus. In an embodiment, for example, the input image data IMG may include red image data, green image data and blue image data. The input image data IMG may include white image data. In another embodiment, for example, the input image data IMG may include magenta image data, cyan image data and yellow image data. The input control signal CONT may include a master clock signal and a data enable signal. The input control signal CONT may further include a vertical synchronizing signal and a horizontal synchronizing signal.

The driving controller 200 may generate a first control signal CONT1, a second control signal CONT2, a third control signal CONT3 and a data signal DATA based on the input image data IMG and the input control signal CONT.

The driving controller 200 may generate the first control signal CONT1 for controlling an operation of the gate emission driver 300 based on the input control signal CONT, and output the first control signal CONT1 to the gate emission driver 300. The first control signal CONT1 may include a vertical start signal and a gate clock signal.

The driving controller 200 may generate the second control signal CONT2 for controlling an operation of the data driver 500 based on the input control signal CONT, and output the second control signal CONT2 to the data driver 500. The second control signal CONT2 may include a horizontal start signal and a load signal.

The driving controller 200 may generate the data signal DATA based on the input image data IMG. The driving controller 200 may output the data signal DATA to the data driver 500.

The driving controller 200 may generate the third control signal CONT3 for controlling an operation of the gamma reference voltage generator 400 based on the input control signal CONT, and output the third control signal CONT3 to the gamma reference voltage generator 400.

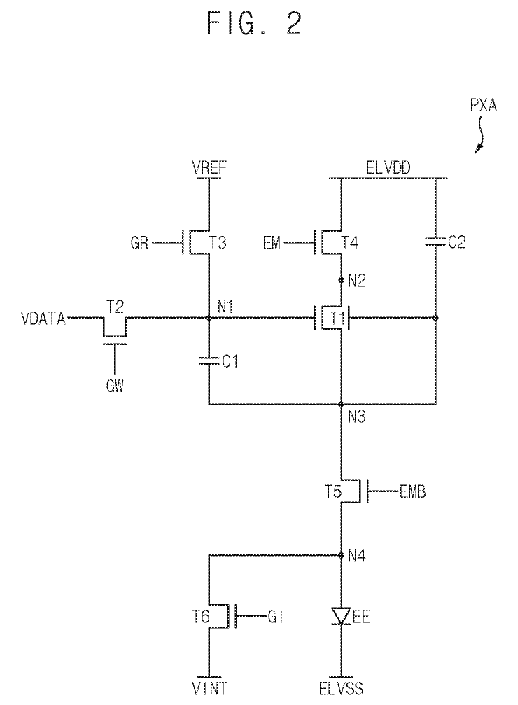

The gate emission driver 300 may generate gate signals driving the gate lines GL and emission signals driving the emission lines EL in response to the first control signal CONT1 received from the driving controller 200. The gate emission driver 300 may output the gate signals to the gate lines GL. The gate emission driver 300 may output the emission signals to the emission lines EL. In an embodiment, for example, the gate signals may include an initialization gate signal GI of FIG. 2, a write gate signal GW of FIG. 2 and a control gate signal GR of FIG. 2. In an embodiment, for example, the emission signals may include a first emission signal EMB of FIG. 2 and a second emission signal EM of FIG. 2.

In an embodiment, the gate emission driver 300 may be disposed in the peripheral region. In an embodiment, for example, the gate emission driver 300 may be integrated in the peripheral region.

The gamma reference voltage generator 400 may generate a gamma reference voltage VGREF in response to the third control signal CONT3 received from the driving controller 200. The gamma reference voltage generator 400 may provide the gamma reference voltage VGREF to the data driver 500. The gamma reference voltage VGREF may have a value corresponding to a level of the data signal DATA.

In an embodiment, the gamma reference voltage generator 400 may be disposed in the driving controller 200, or in the data driver 500.

The data driver 500 may receive the second control signal CONT2 and the data signal DATA from the driving controller 200, and receive the gamma reference voltages VGREF from the gamma reference voltage generator 400. The data driver 500 may convert the data signal DATA into data voltages VDATA having an analog type using the gamma reference voltages VGREF. The data driver 500 may output the data voltages VDATA to the data lines DL.

In an embodiment, the data driver 500 may be disposed in the peripheral region of the display panel 100. In an embodiment, for example, the data driver 500 may be integrated in the peripheral region of the display panel 100.

FIG. 2 is a circuit diagram illustrating an example of a pixel PX included in a display device 1 of FIG. 1.

Referring to FIG. 1 and FIG. 2, an embodiment of a pixel PXA may include first to sixth transistors T1, T2, T3, T4, T5 and T6, a first capacitor C1, a second capacitor C2 and a light emitting element EE.

The first transistor T1 may include a control electrode connected to a first node N1, a first electrode connected to a second node N2 and a second electrode connected to a third node N3. In an embodiment, the first transistor T1 may further include a second control electrode connected to the third node N3. The first transistor T1 may generate a driving current based on a voltage of the first node N1. In such an embodiment, the first transistor T1 may be called as a driving transistor.

The second transistor T2 may include a control electrode that receives the write gate signal GW, a first electrode that receives the data voltage VDATA and a second electrode connected to the first node N1. The second transistor T2 may apply the data voltage VDATA to the first node N1 in response to the write gate signal GW. In such an embodiment , the second transistor T2 may be called as a write transistor.

The third transistor T3 may include a control electrode that receives the control gate signal GR, a first electrode that receives a reference voltage VREF and a second electrode connected to the first node N1. The third transistor T3 may apply the reference voltage VREF to the first node N1 in response to the control gate signal GR. In such an embodiment , the third transistor T3 may be called as an initialization transistor.

The fourth transistor T4 may include a control electrode that receives a second emission signal EM, a first electrode that receives the first power voltage ELVDD and a second electrode connected to the second node N2. The fourth transistor T4 may apply the first power voltage ELVDD to the second node N2 in response to the second emission signal EM. In such an embodiment , the fourth transistor T4 may be called as a first emission control transistor.

The fifth transistor T5 may include a control electrode that receives a first emission signal EMB, a first electrode connected to the third node N3 and a second electrode connected to a fourth node N4. The fifth transistor T5 may connect the third node N3 and the fourth node N4 to each other in response to the first emission signal EMB. In such an embodiment , the fifth transistor T5 may be called as a second emission control transistor.

The sixth transistor T6 may include a control electrode that receives the initialization gate signal GI, a first electrode that receives an initialization voltage VINT and a second electrode connected to the fourth node N4. The sixth transistor T6 may apply the initialization voltage VINT to the fourth node N4 in response to the initialization gate signal GI. In an embodiment, the initialization voltage VINT may be substantially same as a second power voltage ELVSS. In an embodiment, the initialization voltage VINT may be lower than the second power voltage ELVSS. In such an embodiment , the sixth transistor T6 may be called as a light emitting element initialization transistor.

The first capacitor C1 may include a first electrode connected to the first node N1 and a second electrode connected to the third node N3. In such an embodiment , the first capacitor C1 may be called as a storage capacitor.

The second capacitor C2 may include a first electrode that receives the first power voltage ELVDD and a second electrode connected to the third node N3. In such an embodiment , the second capacitor C2 may be called as a hold capacitor.

The light emitting element EE may include a first electrode connected to the fourth node N4 and a second electrode that receives the second power voltage ELVSS. The light emitting element EE may emit light based on the driving current. In an embodiment, the light emitting element EE may be an organic light emitting diode (OLED), but not limited thereto. In another embodiment, the light emitting element EE may be nano light emitting diode (NED), a quantum dot (QD) light emitting diode, a micro light emitting diode, an inorganic light emitting diode, or any other suitable light emitting element.

In an embodiment, the first to sixth transistors T1, T2, T3, T4, T5 and T6 may be N-type transistors. In an embodiment, the first to sixth transistorsT1, T2, T3, T4, T5 and T6 may be oxide transistors.

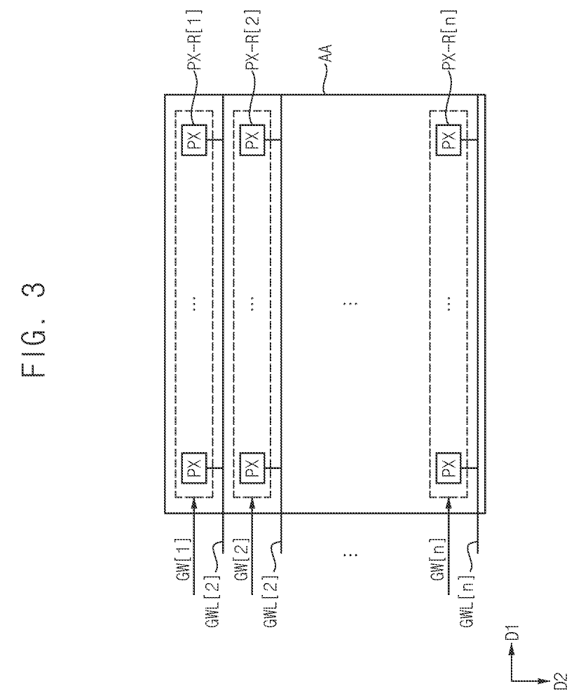

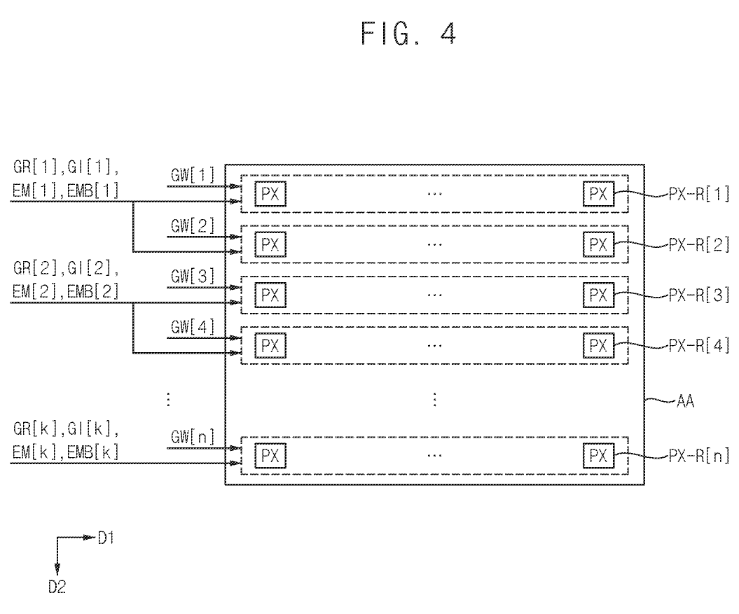

FIG. 3 is a diagram illustrating an example of display region AA of a display panel 100 included in a display device 1 of FIG. 1. FIG. 4 is a diagram illustrating an example of signals applied to a display region AA of FIG. 3.

Referring to FIG. 1 to FIG. 4, the plurality of pixels PX may be located on a display region AA. In an embodiment, the plurality of pixels PX may be arranged in a matrix form. In an embodiment, for example, a plurality of pixel-rows PX-R[1], PX-R[2] to PX-R[n] may be located on the display region AA. The pixel-row may be pixels PX connected to a same write gate line. In an embodiment, for example, the first pixel-row PX-R[1] may be connected to the first write gate line GWL[1]. The first write gate signal GW[1] may be outputted to the first write gate line GWL[1]. In an embodiment, for example, the second pixel-row PX-R[2] may be connected to the second write gate line GWL[2]. The second write gate signal GW[2] may be outputted to the second write gate line GWL[2]. In an embodiment, for example, the N-th pixel-row PX-R[n] may be connected to the N-th write gate line GWL[n]. The N-th write gate signal GW[n] may be outputted to the N-th write gate line GWL[n]. Here, N is a positive integer. In an embodiment, the write gate lines GWL[1], GWL[2] to GWL[n] may extend in the first direction D1.

The control gate signal GR may include first to K-th control gate signals GR[1], GR[2] to GR[k]. Here, K is a positive integer lower than the N. A timing of the first control gate signal GR[1] may be inconsistent with (or different from) a timing of the second control gate signal GR[2]. In an embodiment, for example, an activation level timing of the second control gate signal GR[2] may be delayed from an activation level timing of the first control gate signal GR[1]. In an embodiment, for example, the second to K-th control gate signals GR[2] to GR[k] may have sequentially delayed timing.

The initialization gate signal GI may include first to K-th initialization gate signals GI[1], GI[2] to GI[k]. A timing of the first initialization gate signal GI[1] may be inconsistent with a timing of the second initialization gate signal GI[2]. In an embodiment, for example, an activation level timing of the second initialization gate signal GI[2] may be delayed from an activation level timing of the first initialization gate signal GI[1]. In an embodiment, for example, the second to K-th initialization gate signals GI[2] to GI[k] may have sequentially delayed timing.

The first emission signal EMB may include first-first to first-K-th emission signals EMB[1], EMB[2] to EMB[k]. Here, the first-first emission signal EMB[1] is a first signal of the first emission signal EMB (i.e., a first first emission signal) and first-K-th emission signal EMB[K] is a K-th signal of the first emission signal EMB (i.e., K-th first emission signal). A timing of the first-first emission signal EMB[1] may be inconsistent with a timing of the first-second emission signal EMB[2]. In an embodiment, for example, an activation level timing of the first-second emission signal EMB[2] may be delayed from an activation level timing of the first-first emission signal EMB[1]. In an embodiment, for example, the first-second to first-K-th emission signals EMB[2] to EMB[k] may have sequentially delayed timing.

The second emission signal EM may include second-first to second-K-th emission signals EM[1], EM[2] to EM[k]. Here, the second-first emission signal EM[1] is a first signal of the second emission signal EM, i.e., a first second emission signal, and the second-K-th emission signal EM[K] is a K-th signal of the second emission signal EM, i.e., K-th second emission signal. A timing of the second-first emission signal EM[1] may be inconsistent with a timing of the second-second emission signal EM[2]. In an embodiment, for example, an activation level timing of the second-second emission signal EM[2] may be delayed from an activation level timing of the second-first emission signal EM[1]. In an embodiment, for example, the second-second to second-K-th emission signals EM[2] to EM[k] may have sequentially delayed timing.

In an embodiment, the first control gate signal GR[1] may be applied to the first pixel-row PX-R[1] and the second pixel-row PX-R[2]. In an embodiment, for example, the first pixel-row PX-R[1] and the second pixel-row PX-R[2] may receive a same control gate signal GR or the control gate signal GR having a same timing. The second control gate signal GR[2] may be applied to the third pixel-row PX-R[3] and the fourth pixel-row PX-R[4]. In an embodiment, for example, the third pixel-row PX-R[3] and the fourth pixel-row PX-R[4] may receive a same control gate signal GR or the control gate signal GR having a same timing. A timing of the control gate signal GR applied to the first pixel-row PX-R[1] may be inconsistent with a timing of the control gate signal GR applied to the third pixel-row PX-R[3]. The K-th control gate signal GR[k] may be applied to the N-1-th pixel-row PX-R[n-1] and the N-th pixel-row PX-R[n]. In an embodiment, for example, the N-1-th pixel-row PX-R[n-1] and the N-th pixel-row PX-R[n] may receive a same control gate signal GR or the control gate signal GR having a same timing.

In an embodiment, the first initialization gate signal GI[1] may be applied to the first pixel-row PX-R[1] and the second pixel-row PX-R[2]. In an embodiment, for example, the first pixel-row PX-R[1] and the second pixel-row PX-R[2] may receive a same initialization gate signal GI or the initialization gate signal GI having a same timing. The second initialization gate signal GI[2] may be applied to the third pixel-row PX-R[3] and the fourth pixel-row PX-R[4]. In an embodiment, for example, the third pixel-row PX-R[3] and the fourth pixel-row PX-R[4] may receive a same initialization gate signal GI or the initialization gate signal GI having a same timing. A timing of the initialization gate signal GI applied to the first pixel-row PX-R[1] may be inconsistent with a timing of the initialization gate signal GI applied to the third pixel-row PX-R[3]. The K-th initialization gate signal GI[k] may be applied to the N-1-th pixel-row PX-R[n-1] and the N-th pixel-row PX-R[n]. In an embodiment, for example, the N-1-th pixel-row PX-R[n-1] and the N-th pixel-row PX-R[n] may receive a same initialization gate signal GI or the initialization gate signal GI having a same timing.

In an embodiment, the first-first emission signal EMB[1] may be applied to the first pixel-row PX-R[1] and the second pixel-row PX-R[2]. In an embodiment, for example, the first pixel-row PX-R[1] and the second pixel-row PX-R[2] may receive a same first emission signal EMB or the first emission signal EMB having a same timing. The first-second emission signal EMB[2] may be applied to the third pixel-row PX-R[3] and the fourth pixel-row PX-R[4]. In an embodiment, for example, the third pixel-row PX-R[3] and the fourth pixel-row PX-R[4] may receive a same first emission signal EMB or the first emission signal EMB having a same timing. A timing of the first emission signal EMB applied to the first pixel-row PX-R[1] may be inconsistent with a timing of the first emission signal EMB applied to the third pixel-row PX-R[3]. The first-K-th emission signal EMB[k] may be applied to the N-1-th pixel-row PX-R[n-1] and the N-th pixel-row PX-R[n]. In an embodiment, for example, the N-1-th pixel-row PX-R[n-1] and the N-th pixel-row PX-R[n] may receive a same first emission signal EMB or the first emission signal EMB having a same timing.

In an embodiment, the second-first emission signal EM[1] may be applied to the first pixel-row PX-R[1] and the second pixel-row PX-R[2]. In an embodiment, for example, the first pixel-row PX-R[1] and the second pixel-row PX-R[2] may receive a same second emission signal EM or the second emission signal EM having a same timing. The second-second emission signal EM[2] may be applied to the third pixel-row PX-R[3] and the fourth pixel-row PX-R[4]. In an embodiment, for example, the third pixel-row PX-R[3] and the fourth pixel-row PX-R[4] may receive a same second emission signal EM or the second emission signal EM having a same timing. A timing of the second emission signal EM applied to the first pixel-row PX-R[1] may be inconsistent with a timing of the second emission signal EM applied to the third pixel-row PX-R[3]. The second-K-th emission signal EM[k] may be applied to the N-1-th pixel-row PX-R[n-1] and the N-th pixel-row PX-R[n]. In an embodiment, for example, the N-1-th pixel-row PX-R[n-1] and the N-th pixel-row PX-R[n] may receive a same second emission signal EM or the second emission signal EM having a same timing.

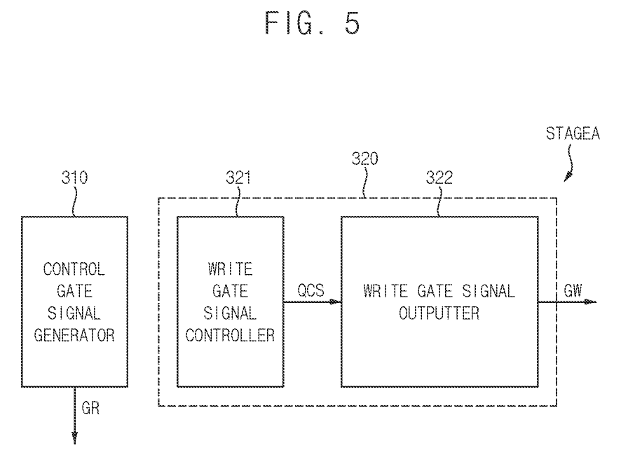

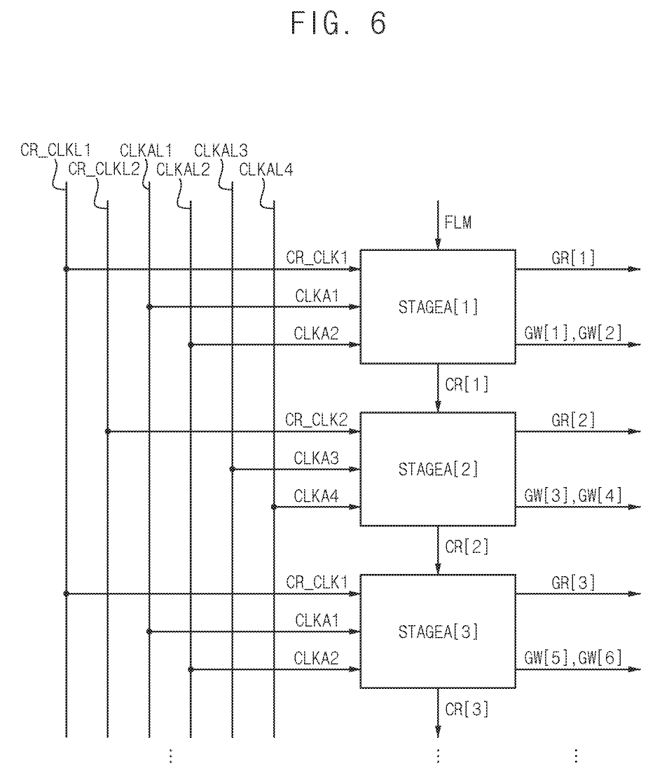

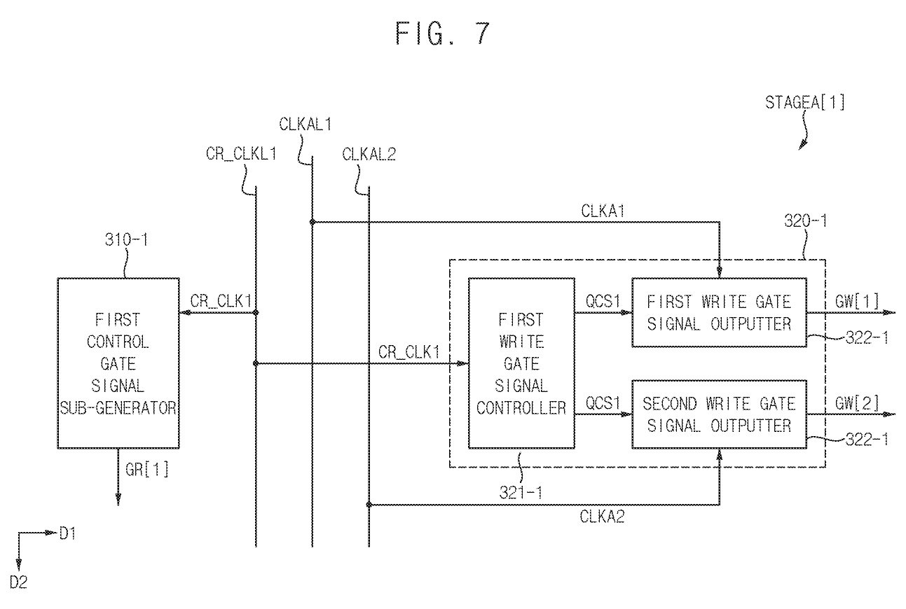

FIG. 5 is a block diagram illustrating an example of stages included in a gate emission driver 300 of FIG. 1. FIG. 6 is a diagram illustrating an example of location of stage STAGEA of FIG. 6. FIG. 7 is a block diagram illustrating an example of a first stage STAGEA[1] included in stages STAGEA[1], STAGEA[2], … of FIG. 6.

Referring to FIG. 1 to FIG. 7, the gate emission driver 300 may include a first carry clock line CR_CLKL1, a second carry clock line CR_CLKL2, a first write gate clock line CLKAL1, a second write gate clock line CLKAL2, a third write gate clock line CLKAL3 and a fourth write gate clock line CLKA4. The gate emission driver 300 may include a plurality of stages STAGEA[1], STAGEA[2], … .

A stage STAGEA may include a control gate signal generator 310 and a write gate signal generator 320. The control gate signal generator 310 may output the control gate signal GR. The write gate signal generator 320 may include a write gate signal controller 321 and a write gate signal outputter 322. The write gate signal controller 321 may output a common control signal QCS. The write gate signal outputter 322 may output the write gate signal GW based on the common control signal QCS.

The first stage STAGEA[1] may be connected to the first carry clock line CR_CLKL1, the first write gate clock line CLKAL1 and the second write gate clock line CLKAL2. The first stage STAGEA[1] may receive a first carry clock signal CR_CLK1, a first write gate clock signal CLKA1 and a second write gate clock signal CLKA2. The first stage STAGEA[1] may receive a vertical start signal FLM. The first stage STAGEA[1] may generate a first control gate signal GR[1], a first write gate signal GW[1] and a second write gate signal GW[2] based on the vertical start signal FLM, the first carry clock signal CR_CLK1, the first write gate clock signal CLKA1 and the second write gate clock signal CLKA2. The first stage STAGEA[1] may output a first carry signal CR[1] based on the vertical start signal FLM and the first carry clock signal CR_CLK1.

The second stage STAGEA[2] may be connected to the second carry clock line CR_CLKL2, the third write gate clock line CLKAL3 and the fourth write gate clock line CLKAL4. The second stage STAGEA[2] may receive a second carry clock signal CR_CLK2, a third write gate clock signal CLKA3 and a fourth write gate clock signal CLKA4. The second stage STAGEA[2] may receive the first carry signal CR[1]. The second stage STAGEA[2] may generate a second control gate signal GR[2], a third write gate signal GW[3] and a fourth write gate signal GW[4] based on the first carry signal CR[1], the second carry clock signal CR_CLK2, the third write gate clock signal CLKA3 and the fourth write gate clock signal CLKA4. The first stage STAGEA[1] may output a second carry signal CR[2] based on the first carry signal CR[1] and the second carry clock signal CR_CLK2.

The third stage STAGEA[3] may be connected to the first carry clock line CR_CLKL1, the first write gate clock line CLKAL1 and the second write gate clock line CLKAL2. The third stage STAGEA[3] may receive the first carry clock signal CR_CLK1, the first write gate clock signal CLKA1 and the second write gate clock signal CLKA2. The third stage STAGEA[3] may receive the second carry signal CR[2]. The third stage STAGEA[3] may generate a third control gate signal GR[3], a fifth write gate signal GW[5] and a sixth write gate signal GW[6] based on the second carry signal CR[2], the first carry clock signal CR_CLK1, the first write gate clock signal CLKA1 and the second write gate clock signal CLKA2. The third stage STAGEA[3] may output a third carry signal CR[3] based on the second carry signal CR[2] and the first carry clock signal CR_CLK1.

In an embodiment, as shown in FIG. 7, the first stage STAGEA[1] may include a first control gate signal sub-generator 310-1 and a first write gate signal generator 320-1.

The first control gate signal sub-generator 310-1 may be connected to the first carry clock line CR_CLKL1. The first control gate signal sub-generator 310-1 may receive the first carry clock signal CR_CLK1. The first control gate signal sub-generator 310-1 may generate the first control gate signal CR[1].

The first write gate signal generator 320-1 may include a first write gate signal controller 321-1, a first write gate signal outputter 322-1 and a second write gate signal outputter 322-1.

The first write gate signal controller 321-1 may be connected to the first carry clock line CR_CLKL1. The first write gate signal controller 321-1 may output a first common control signal QCS1 based on the first carry clock signal CR_CLK1. The first write gate signal controller 321-1 may output the first common control signal QCS1 to the first write gate signal outputter 322-1 and the second write gate signal outputter 322-2.

The first write gate signal outputter 322-1 may output the first write gate signal GW[1] based on the first write gate clock signal CLKA1 and the first common control signal QCS1. The second write gate signal outputter 322-2 may output the second write gate signal GW[2] based on the second write gate clock signal CLKA2 and the first common control signal QCS1.

In an embodiment, the first control gate signal sub-generator 310-1 may be connected to the first carry clock line CR_CLKL1. The first write gate signal generator 320-1 may be connected to the first carry clock line CR_CLK1. The first control gate signal sub-generator 310-1 and first write gate signal generator 320-1 may be connected to a same clock line. Accordingly, the gate emission driver 300 may not include additional clock line for outputting (or transmitting) a clock signal to the first control gate signal sub-generator 310-1. Accordingly, an integration of the gate emission driver 300 may be improved. Additionally, the additional clock signal may not be outputted, such that a power consumption of the display device 1 may be reduced.

In an embodiment, the first write gate signal controller 321-1 may output the first common control signal QCS1. The first write gate signal outputter 322-1 may output the first write gate signal GW[1] based on the first common control signal QCS1, and the second write gate signal outputter 322-2 may output the second write gate signal GW[2] based on the firs common control signal QCS1. The first write gate signal outputter 322-1 and the second write gate signal outputter 322-2 may generate write gate signals GW[1] and GW[2] based on the first common control signal QCS1, so that an integration of the gate emission driver 300 may be further improved.

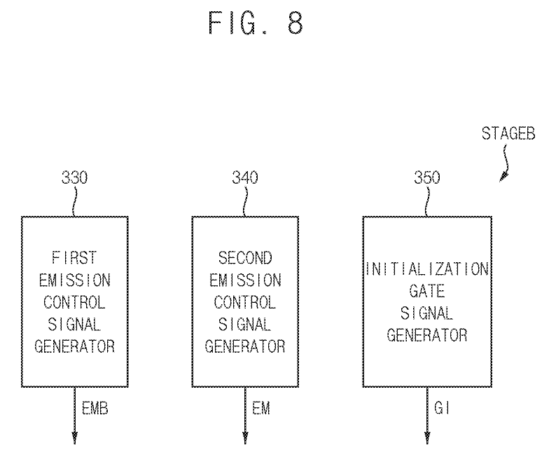

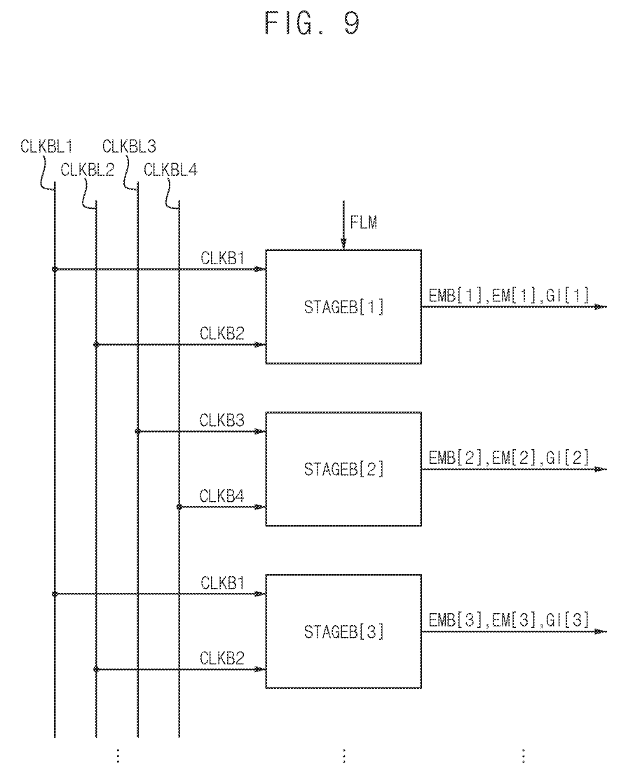

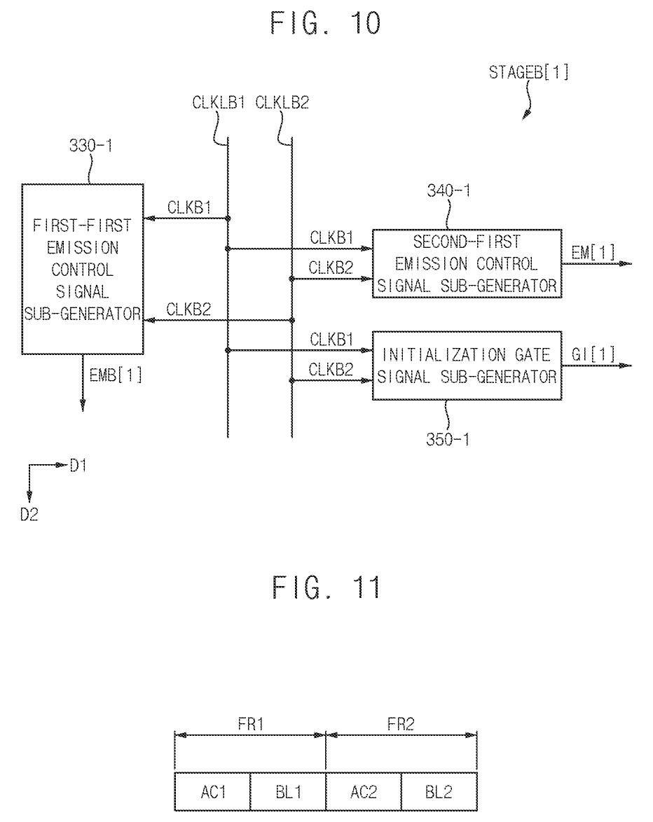

FIG. 8 is a block diagram illustrating an example of stages included in a gate emission driver 300 of FIG. 1. FIG. 9 is a diagram illustrating an example of location of stage STAGEB of FIG. 8. FIG. 10 is a block diagram illustrating an example of a first stage STAGEB[1] included in stages STAGEB[1], STAGEB[2], … of FIG. 9.

Referring to FIG. 1 to FIG. 4 and FIG. 8 to FIG. 10, an embodiment of the gate emission driver 300 may include a first clock line CLKBL1, a second clock line CLKBL2, a third clock line CLKBL3 and a fourth gate clock line CLKBL4. The gate emission driver 300 may include a plurality of stages STAGEB[1], STAGEB[2], STAGEB[3], … . The stage STAGEB may include a first emission control signal generator 330, a second emission control signal generator 340 and an initialization gate signal generator 350. The first emission control signal generator 330 may output the first emission signal EMB. The second emission control signal generator 340 may output the second emission signal EM. The initialization gate signal generator 350 may output the initialization gate signal GI.

In an embodiment, for example, the gate emission driver 300 may include first to K-th stages.

The first stage STAGEB[1] may be connected to the first clock line CLKBL1 and the second clock line CLKBL2. The first stage STAGEB[1] may receive the first clock signal CLKB1 and the second clock signal CLKB2. The first stage STAGEB[1] may receive the vertical start signal FLM. The first stage STAGEB[1] may generate a first-first emission signal EMB[1], a second-first emission signal EM[1] and a first initialization gate signal GI[1] based on the vertical start signal FLM, the first clock signal CLKB1 and the second clock signal CLKB2. In an embodiment, the first stage STAGEB[1] may output a carry signal to the second stage SATGEB[2]. In an embodiment, the first stage STAGEB[1] may output one signal selected from the first-first emission signal EMB[1], the second-first emission signal EM[1] and the first initialization gate signal GI[1] to the second stage STAGEB[2]. In an embodiment, for example, the carry signal may be the one signal.

The second stage STAGEB[2] may be connected to the third clock line CLKBL3 and the fourth clock line CLKBL4. The second stage STAGEB[2] may receive the third clock signal CLKB3 and the fourth clock signal CLKB4. The second stage STAGEB[2] may receive the carry signal from the first stage STAGEB[1]. The second stage STAGEB[2] may generate a first-second emission signal EMB[2], a second-second emission signal EM[2] and a second initialization gate signal GI[2] based on the carry signal from the first stage STAGEB[1], the third clock signal CLKB3 and the fourth clock signal CLKB4. In an embodiment, the second stage STAGEB[2] may output a carry signal to the third stage SATGEB[3]. In an embodiment, the second stage STAGEB[2] may output one signal selected from the first-second emission signal EMB[2], the second-second emission signal EM[2] and the second initialization gate signal GI[2] to the third stage STAGEB[3].

The third stage STAGEB[3] may be connected to the first clock line CLKBL1 and the second clock line CLKBL2. The third stage STAGEB[3] may receive the first clock signal CLKB1 and the second clock signal CLKB2. The third stage STAGEB[3] may receive the carry signal from the second stage STAGEB[2]. The third stage STAGEB[3] may generate a first-third emission signal EMB[3], a second-third emission signal EM[3] and a third initialization gate signal GI[3] based on the carry signal from the second stage STAGEB[2], the first clock signal CLKB1 and the second clock signal CLKB2. In an embodiment, the third stage STAGEB[3] may output a carry signal to the fourth stage. In an embodiment, the third stage STAGEB[3] may output one signal selected from the first-third emission signal EMB[3], the second-third emission signal EM[3] and the third initialization gate signal GI[3] to the fourth stage.

In an embodiment, the first emission control signal generator 330 may include first-first to first-k-th emission control signal sub-generators. The first-first emission control signal sub-generator 330-1 may output the first-first emission signal EMB[1]. The first-second emission control signal sub-generator may output the first-second emission signal EMB[2]. The first-K-th emission control signal sub-generator may output the first-K-th emission signal EMB[k].

In an embodiment, the second emission control signal generator 340-1 may include second-first to second-k-th emission control signal sub-generators. The second-first emission control signal sub-generator 340-1 may output the second-first emission signal EM[1]. The second-second emission control signal sub-generator may output the second-second emission signal EM[2]. The second-K-th emission control signal sub-generator may output the second-K-th emission signal EM[k].

In an embodiment, the initialization gate signal generator 350 may include first to K-th initialization gate signal sub-generators. The first initialization gate signal sub-generator 350-1 may output a first initialization gate signal GI[1]. The second initialization gate signal sub-generator may output a second initialization gate signal GI[2]. The K-th initialization gate signal sub-generator may output a K-th initialization gate signal GI[k].

The first stage STAGEB[1] may include a first-first emission control signal sub-generator 330-1, a second-first emission control signal sub-generator 340-1 and a first initialization gate signal generator 350-1.

The first-first emission control signal sub-generator 330-1 may be connected to the first clock line CLKBL1 and the second clock line CLKBL2. The first-first emission control signal sub-generator 330-1 may receive a first clock signal CLKB1 and a second clock signal CLKB2. The first-first emission control signal sub-generator 330-1 may generate a first-first emission signal EMB[1] based on the first clock signal CLKB1 and the second clock signal CLKB2.

The second-first emission control signal sub-generator 340-1 may be connected to the first clock line CLKBL1 and the second clock line CLKBL2. The second-first emission control signal sub-generator 340-1 may receive the first clock signal CLKB1 and the second clock signal CLKB2. The second-first emission control signal sub-generator 340-1 may generate a second-first emission signal EM[1] based on the first clock signal CLKB1 and the second clock signal CLKB2.

The first initialization gate signal sub-generator 350-1 may be connected to the first clock line CLKBL1 and the second clock line CLKBL2. The first initialization gate signal sub-generator 350-1 may receive the first clock signal CLKB1 and the second clock signal CLKB2. The first initialization gate signal sub-generator 350-1 may generate a first initialization gate signal GI[1] based on the first clock signal CLKB1 and the second clock signal CLKB2.

In an embodiment, each of the first-first emission control signal sub-generator 330-1, second-first emission control signal sub-generator 340-1 and the first initialization gate signal sub-generator 350-1 may be connected to the first clock line CLKBL1 and the second clock line CLKBL2. In an embodiment, for example, the first-first emission control signal sub-generator 330-1, second-first emission control signal sub-generator 340-1 and the first initialization gate signal sub-generator 350-1 may share the clock lines. Accordingly, an integration of the gate emission driver 300 may be improved. Additionally, the additional clock signal may not be outputted, such that a power consumption of the display device 1 may be reduced.

In an embodiment, the first-first emission signal EMB[1], the second-first emission signal EM[1] and the first initialization gate signal GI[1] may be applied to the first pixel-row PX-R[1] and the second pixel-row PX-R[2]. Accordingly, a pitch of the first emission control signal generator 330, the second emission control signal generator 340 and the initialization gate signal generator 350 may be secured. In an embodiment, for example, the pitch of the first emission control signal generator 330, the second emission control signal generator 340 and the initialization gate signal generator 350 in the second direction D2 may be secured. Accordingly, the second-first to second-K-th emission control signal sub-generators and the first to K-th initialization gate signal sub-generators may be located sequentially.

In an embodiment, the second-first to second-K-th emission control signal sub-generators and the first to K-th initialization gate signal sub-generators may be located alternately (or arranged alternately with each other). In an embodiment, for example, the second-first to second-K-th emission control signal sub-generators and the first to K-th initialization gate signal sub-generators may be located alternately in the second direction D2. In an embodiment, for example, the first initialization gate signal sub-generator may be spaced apart from the second-first emission control signal sub-generator in the second direction D2. In an embodiment, for example, the second-second emission control signal sub-generator may be spaced apart from the first initialization gate signal sub-generator in the second direction D2. In an embodiment, for example, the second initialization gate signal sub-generator may be spaced apart from the second-second emission control signal sub-generator in the second direction D2. In an embodiment, the first-first to first-K-th emission control signal sub-generators may be located (or arranged) sequentially in the second direction D2.

In an embodiment, the first-first to first-K-th emission control signal sub-generators and the first to K-th initialization gate signal sub-generators may be located alternately. When the first-first to first-K-th emission control signal sub-generators and the first to K-th initialization gate signal sub-generators are located alternately, the second-first to second-K-th emission control signal sub-generators may be located sequentially. In an embodiment, the first-first to first-K-th emission control signal sub-generators and the second-first to second-K-th emission control signal sub-generators may be located alternately. When the first-first to first-K-th emission control signal sub-generators and the second-first to second-K-th emission control signal sub-generators are located alternately, the first to K-th initialization gate signal sub-generators may be located sequentially.

In an embodiment, the first-first emission control signal sub-generator 330-1, second-first emission control signal sub-generator 340-1 and the first initialization gate signal sub-generator 350-1 may be connected to the first clock line CLKBL1. Additionally, the first-first emission control signal sub-generator 330-1, second-first emission control signal sub-generator 340-1 and the first initialization gate signal sub-generator 350-1 may be connected to the second clock line CLKBL2. In an embodiment, for example, the first-first emission control signal sub-generator 330-1, second-first emission control signal sub-generator 340-1 and the first initialization gate signal sub-generator 350-1 may be connected to the same clock lines. Accordingly, the number of clock lines included in the gate emission driver 300 may be reduced. Accordingly, an integration of the gate emission driver 300 may be improved. Additionally, the number of clock lines included in the gate emission driver 300 may be reduced, such that a power consumption of the display device 1 may be reduced.

FIG. 11 is a diagram illustrating frame periods FR1 and FR2 in which a pixel PXA of FIG. 2 is driven.

Referring to FIG. 1 to FIG. 11, in an embodiment, frame periods FR1 and FR2 in which a pixel PXA of FIG. 2 is driven may include a first frame period FR1 and a second frame period FR2.

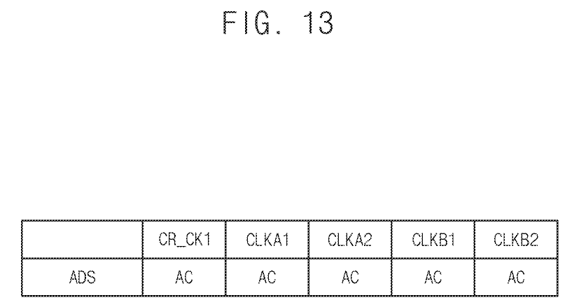

The first frame period FR1 may include a first active period AC1 and a first blank period BL1. In the first active period AC1, the write gate signal GW may have an activation level. In the first active period AC1, the write gate signal GW may have an activation level, so that the data voltage VDATA may be applied to the first node N1. Accordingly, the pixel PXA may emit light based on the data voltage VDATA. In an embodiment, for example, the pixel PXA may emit light based on the data voltage VDATA of a present frame. In an embodiment, for example, the first frame period FR1 may be called as an address period ADS of FIG. 13.

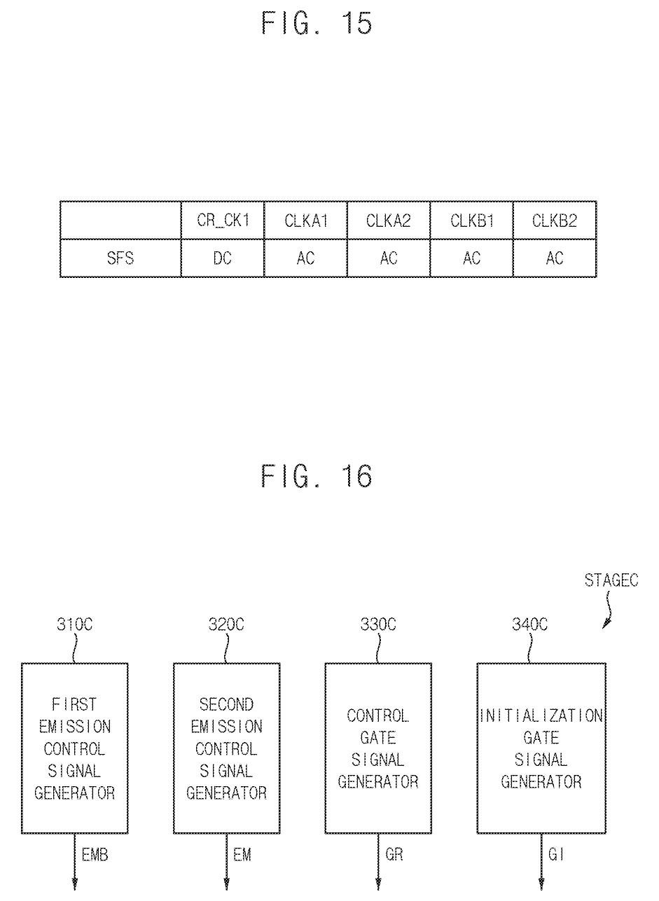

The second frame period FR2 following to the first frame period FR1 may include a second active period AC2 and a second blank period BL2. In the second active period AC2, the write gate signal GW and the control gate signal GR may be maintained as an inactivation level. The write gate signal GW and the control gate signal GR may be maintained as an inactivation level, such that the data voltage VDATA may not be applied to the first node N1. In the second frame period FR2, the reference voltage VREF may not be applied to the first node N1. Accordingly, the pixel PXA may emit light based on the data voltage VDATA of a previous frame. In an embodiment, for example, the pixel PXA may emit light based on the data voltage VDATA of the first frame FR1. In an embodiment, for example, the first frame period FR1 may be called as a self-scan period SFS of FIG. 15.

In an embodiment, the display panel 100 may emit light based on the data voltage VDATA of the previous frame in the self-scan period. Accordingly, in such an embodiment, a driving frequency of the display panel 100 may be variable, such that a power consumption of the display device 1 may be reduced.

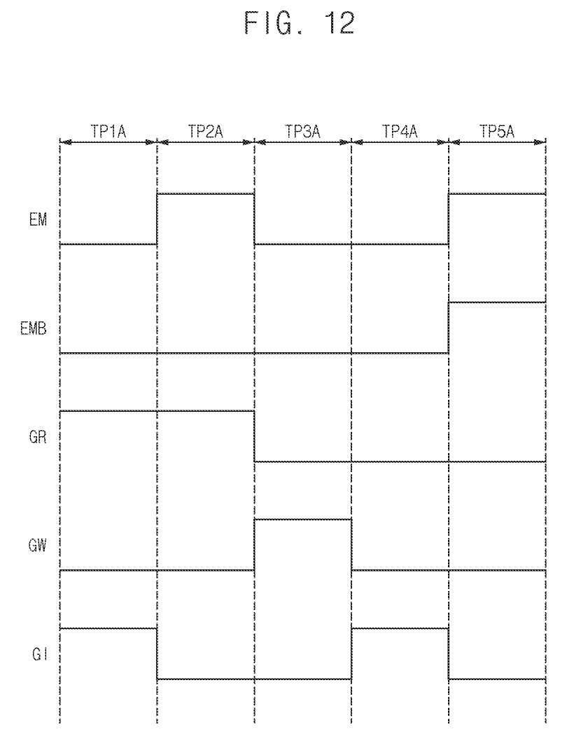

FIG. 12 is a signal timing diagram illustrating signals applied to a pixel PXA of FIG. 2 in a first frame period FR1 of FIG. 11. FIG. 13 is a table illustrating a driving clock signals of FIG. 7 and clock signals of FIG. 10 in a first frame period FR1.

Referring to FIG. 1 to FIG. 13, in an embodiment, the first frame period FR1 may include first to fifth periods TP1A, TP2A, TP3A, TP4A and TP5A.

In the first period TP1A, as shown in FIG. 12, the second emission signal EM may have an inactivation level, the first emission signal EMB may have an inactivation level, the control gate signal GR may have an activation level, the write gate signal GW may have an inactivation, and the initialization gate signal GI may have an activation level. An activation level may be a voltage that allows a transistor to be turned on. An inactivation level may be a voltage that allows a transistor to be turned off.

In the first period TP1A, the sixth transistor T6 may be turned on in response to the initialization gate signal GI. The sixth transistor T6 may be turned on, such that the initialization voltage VINT may be applied to the fourth node N4. The initialization voltage VINT may be applied to the fourth node N4, such that the light emitting element EE may stop emitting. In the first period TP1A, the third transistor T3 may be turned on in response to the control gate signal GR. The third transistor T3 may be turned on, such that the reference voltage VREF may be applied to the first node N1. Accordingly, the first node N1 may be initialized as the reference voltage VREF. In an embodiment, for example, an operation in which the reference voltage VREF is applied to the first node N1 may be called as a data initialization operation.

In the second period TP2A, the second emission signal EM may have an activation level, the first emission signal EMB may have an inactivation level, the control gate signal GR may have an activation level, the write gate signal GW may have an inactivation, and the initialization gate signal GI may have an inactivation level.

In the second period TP2A, the fourth transistor T4 may be turned on in response to the second emission signal EM. The fourth transistor T4 may be turned on, such that the first power voltage ELVDD may be applied to the second node N2.

In the third period TP3A, the second emission signal EM may have an inactivation level, the first emission signal EMB may have an inactivation level, the control gate signal GR may have an inactivation level, the write gate signal GW may have an activation, and the initialization gate signal GI may have an inactivation level.

In the third period TP3A, the second transistor T2 may be turned on in response to the write gate signal GW. When the second transistor T2 may be turned on, such that the data voltage VDATA may be applied to the first node N1. In an embodiment, for example, an operation in which the data voltage VDATA is applied to the first node N1 may be called as a writing operation.

In the fourth period TP4A, the second emission signal EM may have an inactivation level, the first emission signal EMB may have an inactivation level, the control gate signal GR may have an inactivation level, the write gate signal GW may have an inactivation, and the initialization gate signal GI may have an activation level.

In the fourth period TP4A, the sixth transistor T6 may be turned on in response to the initialization gate signal GI. The sixth transistor T6 may be turned on, such that the initialization voltage VINT may be applied to the fourth node N4.

In the fifth period TP5A, the second emission signal EM may have an activation level, the first emission signal EMB may have an activation level, the control gate signal GR may have an inactivation level, the write gate signal GW may have an inactivation, and the initialization gate signal GI may have an inactivation level.

In the fifth period TP5A, the fourth transistor T4 may be turned on in response to the second emission signal EM. In the fifth period TP5A, the fifth transistor T5 may be turned on in response to the first emission signal EMB. In the fifth period TP5A, the sixth transistor T6 may be turned off in response to the initialization gate signal GI. Accordingly, the driving current may be applied to the light emitting element EE. Accordingly, the light emitting element EE may emit light based on the driving current. In the fifth period TP5A, the light emitting element EE may emit light based on the driving current based on the data voltage VDATA of the present frame.

In the first frame period FR1, as shown in FIG. 13, the carry clock signal CR_CK1 for generating the write gate signal GW and the control gate signal GR may be alternate current driven (AC in FIG. 13). Additionally, the write gate clock signals CLKA1 and CLKA2 for generating the write gate signal GW and the control gate signal GR may be alternate current driven. In an embodiment, for example, in the first frame period FR1, the carry clock signal CR_CK1 and the write gate clock signals CLKA1 and CLKA2 may toggle between a high level and a low level. In the first frame period FR1, the common gate clock signals CLKB1 and CLKB2 for generating the initialization gate signal GI, the first emission signal EMB and the second emission signal EM may be alternate current driven. In an embodiment, for example, in the first frame period FR1, the common gate clock signals CLKB1 and CLKB2 may toggle between a high level and a low level.

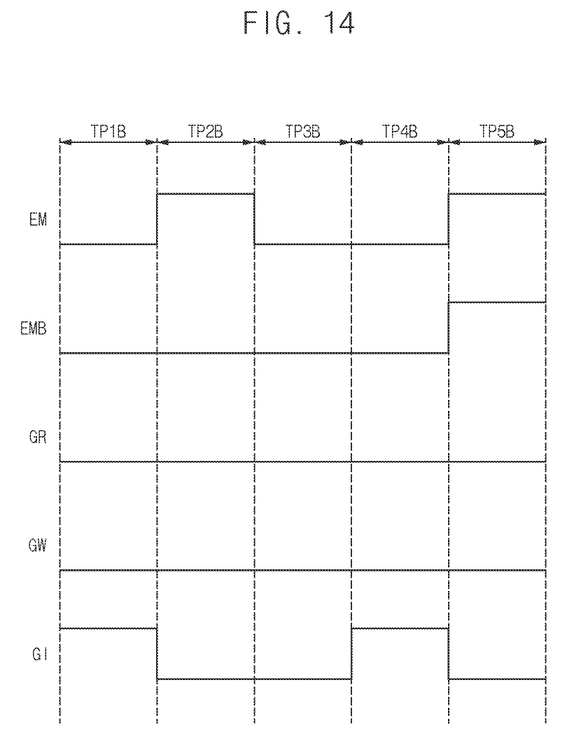

FIG. 14 is a signal timing diagram illustrating signals applied to a pixel PXA of FIG. 2 in a second frame period FR2 of FIG. 11. FIG. 15 is a table illustrating a driving clock signals of FIG. 7 and clock signals of FIG. 10 in a second frame period FR2.

Referring to FIG. 1 to FIG. 15, the second frame period FR2 may include first to fifth periods TP1B, TP2B, TP3B, TP4B and TP5B.

In the first period TP1B, as shown in FIG. 14, the second emission signal EM may have an inactivation level, the first emission signal EMB may have an inactivation level, the control gate signal GR may have an inactivation level, the write gate signal GW may have an inactivation, and the initialization gate signal GI may have an activation level.

In the first period TP1B, the sixth transistor T6 may be turned on in response to the initialization gate signal GI. The sixth transistor T6 may be turned on, such that the initialization voltage VINT may be applied to the fourth node N4. The initialization voltage VINT may be applied to the fourth node N4, such that the light emitting element EE may stop emitting. In the first period TP1B, the control gate signal GR may have an inactivation level. Accordingly, the third transistor T3 may be turned off. The third transistor T3 may be turned off, such that the reference voltage VREF may not be applied to the first node N1. Accordingly, in the first period TP1B, a voltage of the first node N1 may be maintained as the data voltage of the present frame.

In the second period TP2B, the second emission signal EM may have an activation level, the first emission signal EMB may have an inactivation level, the control gate signal GR may have an inactivation level, the write gate signal GW may have an inactivation, and the initialization gate signal GI may have an inactivation level.

In the second period TP2A, the fourth transistor T4 may be turned on in response to the second emission signal EM. The fourth transistor T4 may be turned on, such that the first power voltage ELVDD may be applied to the second node N2.

In the third period TP3B, the second emission signal EM may have an inactivation level, the first emission signal EMB may have an inactivation level, the control gate signal GR may have an inactivation level, the write gate signal GW may have an inactivation, and the initialization gate signal GI may have an inactivation level.

In the third period TP3B, the write gate signal GW may have an inactivation level. Accordingly, the second transistor T2 may be turned off. The second transistor T2 may be turned off, so that the data voltage VDATA may not be applied to the first node N1. In an embodiment, for example, the writing operation may be performed in the third period TP3B. Accordingly, in the third period TP3B, the voltage of the first node N1 may be maintained as the data voltage VDATA of the previous frame.

In the fourth period TP4B, the second emission signal EM may have an inactivation level, the first emission signal EMB may have an inactivation level, the control gate signal GR may have an inactivation level, the write gate signal GW may have an inactivation, and the initialization gate signal GI may have an activation level.

In the fourth period TP4B, the sixth transistor T6 may be turned on in response to the initialization gate signal GI. The sixth transistor T6 may be turned on, such that the initialization voltage VINT may be applied to the fourth node N4.

In the fifth period TP5B, the second emission signal EM may have an activation level, the first emission signal EMB may have an activation level, the control gate signal GR may have an inactivation level, the write gate signal GW may have an inactivation, and the initialization gate signal GI may have an inactivation level.

In the fifth period TP5B, the fourth transistor T4 may be turned on in response to the second emission signal EM. In the fifth period TP5B, the fifth transistor T5 may be turned on in response to the first emission signal EMB. In the fifth period TP5B, the sixth transistor T6 may be turned off in response to the initialization gate signal GI. Accordingly, the driving current may be applied to the light emitting element EE. Accordingly, the light emitting element EE may emit light based on the driving current. In the second frame period FR2, the writing operation may not be performed. Additionally, in the second frame period FR2, the data initialization operation may not be performed. Accordingly, during the second frame period FR2, the voltage of the first node N1 may be maintained as the data voltage VDATA of the previous frame. Accordingly, in the fifth period TP5B, the light emitting element EE may emit light based on the driving current based on the data voltage VDATA of the previous frame.

In the second frame period FR2, as shown in FIG. 15, the carry clock signal CR_CK1 for generating the write gate signal GW and the control gate signal GR may be direct current driven (DC in FIG. 15). The direct current driven may be driven to maintain a constant voltage. In an embodiment, for example, when a signal is driven as the direct current driven, the signal may be maintained as a constant voltage. Accordingly, the write gate signal GW and the control gate signal GR may be maintained as an inactivation level. In the second frame period FR2, the common gate clock signals CLKB1 and CLKB2 for generating the initialization gate signal GI, the first emission signal EMB and the second emission signal EM may be alternate current driven (AC in FIG. 15). In an embodiment, for example, in the first frame period FR1, the common gate clock signals CLKB1 and CLKB2 may toggle between a high level and a low level.

In an embodiment, during the second frame period FR2, the carry clock signal CR_CK1 may be driven as the direct current driven. In an embodiment, for example, during the self-scan period SFS, the carry clock signal CR_CK1 may be driven as the direct current driven. Additionally, the carry clock signal CR_CK1 may be commonly applied to the control gate signal generator 310 and the write gate signal generator 320. In an embodiment, for example, the control gate signal generator 310 and the write gate signal generator 320 may be connected to a same carry clock line. Accordingly, additional clock line for generating the control gate signal GR may not be provided, such that an integration of the gate emission driver 300 may be improved.

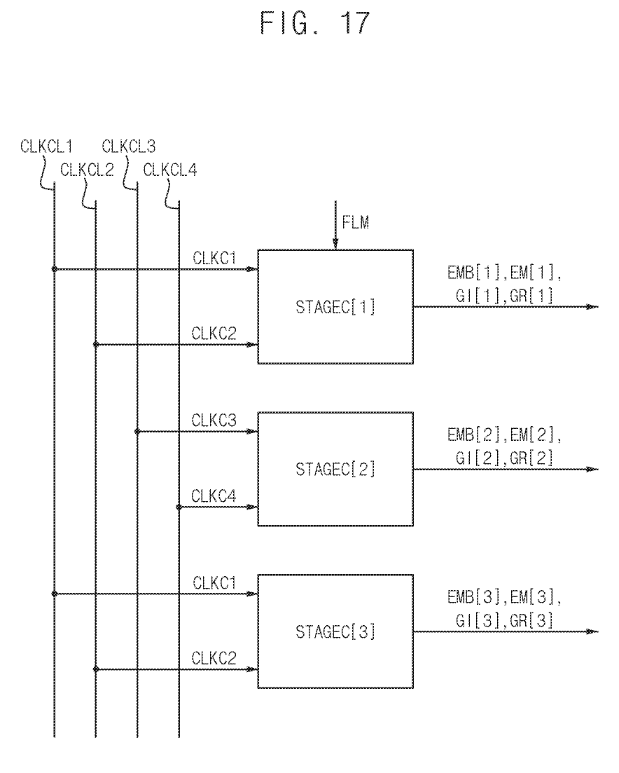

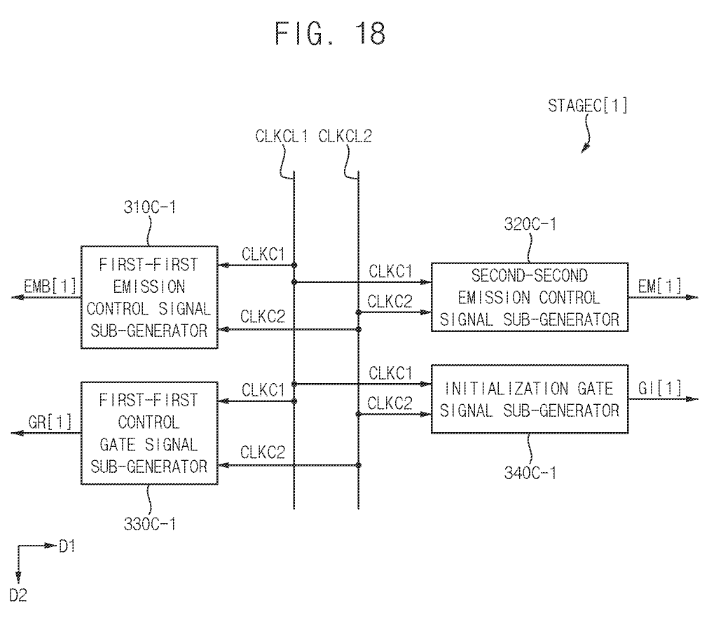

FIG. 16 is a block diagram illustrating an example of stages included in a gate emission driver 300 of FIG. 1. FIG. 17 is a diagram illustrating an example of location of stage STAGEC of FIG. 16. FIG. 18 is a block diagram illustrating an example of a first stage STAGEC[1] included in stages STAGEC[1], STAGEC[2], STAGEC[3], … of FIG. 17.

Referring to FIG. 1 to FIG. 4 and FIG. 16 to FIG. 18, in an embodiment, the gate emission driver 300 may include a first clock line CLKCL1, a second clock line CLKCL2, a third clock line CLKCL3 and a fourth gate clock line CLKCL4. The gate emission driver 300 may include a plurality of stages STAGEC[1], STAGEC[2], STAGEC[3], … . The stage STAGEC may include a first emission control signal generator 310C, a second emission control signal generator 320C, a control gate signal generator 330C and an initialization gate signal generator 340C. The first emission control signal generator 310C may output the first emission signal EMB. The second emission control signal generator 320C may output the second emission signal EM. The control gate signal generator 330C may output the control gate signal GR. The initialization gate signal generator 340C may output the initialization gate signal GI.

In an embodiment, for example, the gate emission driver 300 may include first to K-th stages.

The first stage STAGEC[1] may be connected to the first clock line CLKCL1 and the second clock line CLKCL2. The first stage STAGEC[1] may receive the first clock signal CLKC1 and the second clock signal CLKC2. The first stage STAGEC[1] may receive the vertical start signal FLM. The first stage STAGEC[1] may generate a first-first emission signal EMB[1], a second-first emission signal EM[1], a first control gate signal GR[1] and a first initialization gate signal GI[1] based on the vertical start signal FLM, the first clock signal CLKC1 and the second clock signal CLKC2. In an embodiment, the first stage STAGEC[1] may output a carry signal to the second stage SATGEC[2]. In an embodiment, the first stage STAGEC[1] may output one signal selected from the first-first emission signal EMB[1], the second-first emission signal EM[1], the first control gate signal GR[1] and the first initialization gate signal GI[1] to the second stage STAGEC[2]. In an embodiment, for example, the carry signal may be the one signal.

The second stage STAGEC[2] may be connected to the third clock line CLKCL3 and the fourth clock line CLKCL4. The second stage STAGEC[2] may receive the third clock signal CLKC3 and the fourth clock signal CLKC4. The second stage STAGEC[2] may receive the carry signal from the first stage STAGEC[1]. The second stage STAGEC[2] may generate a first-second emission signal EMB[2], a second-second emission signal EM[2], a second control gate signal GR[2] and a second initialization gate signal GI[2] based on the carry signal from the first stage STAGEC[1], the third clock signal CLKC3 and the fourth clock signal CLKC4. In an embodiment, the second stage STAGEC[2] may output a carry signal to the third stage SATGEC[3]. In an embodiment, the second stage STAGEC[2] may output one signal selected from the first-second emission signal EMB[2], the second-second emission signal EM[2], the second control gate signal GR[2] and the second initialization gate signal GI[2] to the third stage STAGEC[3].

The third stage STAGEC[3] may be connected to the first clock line CLKCL1 and the second clock line CLKCL2. The third stage STAGEC[3] may receive the first clock signal CLKC1 and the second clock signal CLKC2. The third stage STAGEC[3] may receive the carry signal from the second stage STAGEC[2]. The third stage STAGEC[3] may generate a first-third emission signal EMB[3], a second-third emission signal EM[3], a third control gate signal GR[3] and a third initialization gate signal GI[3] based on the carry signal from the second stage STAGEC[2], the first clock signal CLKC1 and the second clock signal CLKC2. In an embodiment, the third stage STAGEC[3] may output a carry signal to the fourth stage. In an embodiment, the third stage STAGEC[3] may output one signal selected from the first-third emission signal EMB[3], the second-third emission signal EM[3], the third control gate signal GR[3] and the third initialization gate signal GI[3] to the fourth stage as the carry signal.

In an embodiment, the first emission control signal generator 310C may include first to K-th emission control signal sub-generators (hereinafter, will be referred to as first-first to first-K-th emission control signal sub-generators, respectively). The first-first emission control signal sub-generator 310C-1 may output the first-first emission signal EMB[1]. The first-second emission control signal sub-generator may output the first-second emission signal EMB[2]. The first-K-th emission control signal sub-generator may output the first-K-th emission signal EMB[k].

In an embodiment, the second emission control signal generator 320C may include first to K-th emission control signal sub-generators (hereinafter, will be referred to as second-first to second-K-th emission control signal sub-generators, respectively). The second-first emission control signal sub-generator 320C-1 may output the second-first emission signal EM[1]. The second-second emission control signal sub-generator may output the second-second emission signal EM[2]. The second-K-th emission control signal sub-generator may output the second-K-th emission signal EM[k].

In an embodiment, the control gate signal generator 330C may include first to K-th control gate signal sub-generators. The first control gate signal sub-generator 330C-1 may output a first initialization gate signal GR[1]. The second control gate signal sub-generator may output a second control gate signal GR[2]. The K-th initialization gate signal sub-generator may output a K-th control gate signal GR[k].

In an embodiment, the initialization gate signal generator 340C may include first to K-th initialization gate signal sub-generators. The first initialization gate signal sub-generator 340C-1 may output a first initialization gate signal GI[1]. The second initialization gate signal sub-generator may output a second initialization gate signal GI[2]. The K-th initialization gate signal sub-generator may output a K-th initialization gate signal GI[k].

The first stage STAGEC[1] may include a first-first emission control signal sub-generator 310C-1, a second-first emission control signal sub-generator 320C-1, a first control gate signal sub-generator 330C-1 and a first initialization gate signal sub-generator 340C-1.

The first-first emission control signal sub-generator 310C-1 may be connected to the first clock line CLKCL1 and the second clock line CLKCL2. The first-first emission control signal sub-generator 310C-1 may receive a first clock signal CLKC1 and a second clock signal CLKC2. The first-first emission control signal sub-generator 310C-1 may generate a first-first emission signal EMB[1] based on the first clock signal CLKC1 and the second clock signal CLKC2.

The second-first emission control signal sub-generator 320C-1 may be connected to the first clock line CLKCL1 and the second clock line CLKCL2. The second-first emission control signal sub-generator 320C-1 may receive the first clock signal CLKC1 and the second clock signal CLKC2. The second-first emission control signal sub-generator 320C-1 may generate a second-first emission signal EM[1] based on the first clock signal CLKC1 and the second clock signal CLKC2.

The first initialization gate signal sub-generator 340C-1 may be connected to the first clock line CLKCL1 and the second clock line CLKCL2. The first initialization gate signal sub-generator 340C-1 may receive the first clock signal CLKC1 and the second clock signal CLKC2. The first initialization gate signal sub-generator 340C-1 may generate a first initialization gate signal GI[1] based on the first clock signal CLKC1 and the second clock signal CLKC2.

The first control gate signal sub-generator 330C-1 may be connected to the first clock line CLKCL1 and the second clock line CLKCL2. The first control gate signal sub-generator 330C-1 may receive the first clock signal CLKC1 and the second clock signal CLKC2. The first control gate signal sub-generator 330C-1 may generate a first control gate signal GR[1] based on the first clock signal CLKC1 and the second clock signal CLKC.2

In an embodiment, the first-first emission control signal sub-generator 310C-1, second-first emission control signal sub-generator 320C-1, the first control gate signal sub-generator 330C-1 and the first initialization gate signal sub-generator 340C-1 may be connected to the first clock line CLKCL1 and the second clock line CLKCL2. In an embodiment, for example, the first-first emission control signal sub-generator 310C-1, second-first emission control signal sub-generator 320C-1, the first control gate signal sub-generator 330C-1 and the first initialization gate signal sub-generator 340C-1 may share the clock lines. Accordingly, an integration of the gate emission driver 300 may be improved. Additionally, the additional clock signal may not be provided, such that a power consumption of the display device 1 may be reduced.

In such an embodiment, the first-first emission signal EMB[1], the second-first emission signal EM[1], the first control gate signal GR[1] and the first initialization gate signal GI[1] may be applied to the first pixel-row PX-R[1] and the second pixel-row PX-R[2]. Accordingly, a pitch of the first emission control signal generator 310C, the second emission control signal generator 320C, the control gate signal generator 330C and the initialization gate signal generator 340C may be secured. In an embodiment, for example, the pitch of the first emission control signal generator 310C, the second emission control signal generator 320C, the control gate signal generator 330C and the initialization gate signal generator 340C in the second direction D2 may be secured. Accordingly, the second-first to second-K-th emission control signal sub-generators and the first to K-th initialization gate signal sub-generators may be located sequentially. Additionally, the first-first to second-K-th emission control signal sub-generators and the first to K-th control gate signal sub-generators may be located sequentially.

In an embodiment, the second-first to second-K-th emission control signal sub-generators and the first to K-th initialization gate signal sub-generators may be located alternately. In an embodiment, for example, the second-first to second-K-th emission control signal sub-generators and the first to K-th initialization gate signal sub-generators may be located alternately in the second direction D2. In an embodiment, for example, the first initialization gate signal sub-generator may be spaced apart from the second-first emission control signal sub-generator in the second direction D2. The second-second emission control signal sub-generator may be spaced apart from the first initialization gate signal sub-generator in the second direction D2. The second initialization gate signal sub-generator may be spaced apart from the second-second emission control signal sub-generator in the second direction D2. In an embodiment, the first-first to first-K-th emission control signal sub-generators may be located sequentially in the second direction D2. In an embodiment, the first-first to first-K-th emission control signal sub-generators and the first to K-th control gate signal sub-generators may be located alternately in the second direction D2.

In an embodiment, the first-first to first-K-th emission control signal sub-generators and the first to K-th initialization gate signal sub-generators may be located alternately. In such an embodiment where the first-first to first-K-th emission control signal sub-generators and the first to K-th initialization gate signal sub-generators are located alternately, the second-first to second-K-th emission control signal sub-generators and the first to K-th control gate signal sub-generators may be located alternately. In an embodiment, the first-first to first-K-th emission control signal sub-generators and the second-first to second-K-th emission control signal sub-generators may be located alternately. When the first-first to first-K-th emission control signal sub-generators and the second-first to second-K-th emission control signal sub-generators are located alternately, the first to K-th initialization gate signal sub-generators and the first to K-th control gate signal sub-generators may be located alternately.

In an embodiment, the first-first emission control signal sub-generator 310C-1, second-first emission control signal sub-generator 320C-1, the first control gate signal sub-generator 330C-1 and the first initialization gate signal sub-generator 340C-1 may be connected to the first clock line CLKCL1. In such an embodiment, the first-first emission control signal sub-generator 310C-1, second-first emission control signal sub-generator 320C-1, the first control gate signal sub-generator 330C-1 and the first initialization gate signal sub-generator 340C-1 may be connected to the second clock line CLKCL2. In an embodiment, for example, the first-first emission control signal sub-generator 310C-1, second-first emission control signal sub-generator 320C-1, the first control gate signal sub-generator 330C-1 and the first initialization gate signal sub-generator 340C-1 may be connected to the same clock lines. Accordingly, the number of clock lines included in the gate emission driver 300 may be reduced. Accordingly, an integration of the gate emission driver 300 may be improved. Additionally, the number of clock lines included in the gate emission driver 300 may be reduced, such that a power consumption of the display device 1 may be reduced.

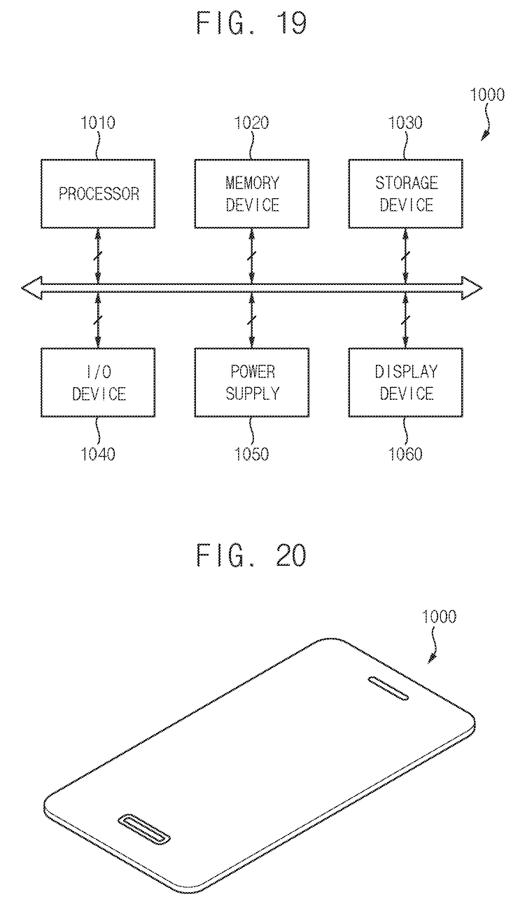

FIG. 19 is a block diagram illustrating an electronic device 1000 according to an embodiment of the invention. FIG. 20 is a diagram illustrating an example in which the electronic device of FIG. 19 is implemented as a smart phone.

Referring to FIG. 19, an embodiment of the electronic device 1000 may include a processor 1010, a memory device 1020, a storage device 1030, an input/output (I/O) device 1040, a power supply 1050, and a display apparatus 1060. Here, the display apparatus 1060 may be the display apparatus of FIG. 1. In an embodiment, the electronic device 1000 may further include a plurality of ports for communicating with a video card, a sound card, a memory card, a universal serial bus (USB) device, another electronic device, etc.

In an embodiment, as illustrated in FIG. 20, the electronic device 1000 may be implemented as a smart phone. However, the electronic device 1000 is not limited thereto. In an embodiment, for example, the electronic device 1000 may be implemented as a cellular phone, a video phone, a smart pad, a smart watch, a tablet personal computer (PC), a car navigation system, a computer monitor, a laptop, a head mounted display (HMD) device, or the like.

The processor 1010 may perform various computing functions or various tasks. The processor 1010 may be a micro-processor, a central processing unit (CPU), an application processor (AP), or the like. The processor 1010 may be coupled to other components via an address bus, a control bus, a data bus, etc. Further, the processor 1010 may be coupled to an extended bus such as a peripheral component interconnection (PCI) bus.

The processor 1010 may output the input image data IMG, the app-on signal APPON and the input control signal CONT to the driving controller 200 of FIG. 1.

The memory device 1020 may store data for operations of the electronic device 1000. In an embodiment, for example, the memory device 1020 may include at least one non-volatile memory device such as an erasable programmable read-only memory (EPROM) device, an electrically erasable programmable read-only memory (EEPROM) device, a flash memory device, a phase change random access memory (PRAM) device, a resistance random access memory (RRAM) device, a nano floating gate memory (NFGM) device, a polymer random access memory (PoRAM) device, a magnetic random access memory (MRAM) device, a ferroelectric random access memory (FRAM) device, or the like and/or at least one volatile memory device such as a dynamic random access memory (DRAM) device, a static random access memory (SRAM) device, a mobile DRAM device, or the like.

The storage device 1030 may include a solid state drive (SSD) device, a hard disk drive (HDD) device, a CD-ROM device, or the like. The I/O device 1040 may include an input device such as a keyboard, a keypad, a mouse device, a touch-pad, a touch-screen, or the like and an output device such as a printer, a speaker, or the like. In some embodiments, the display apparatus 1060 may be included in the I/O device 1040. The power supply 1050 may provide power for operations of the electronic device 1000. The display apparatus 1060 may be coupled to other components via the buses or other communication links.

Referring to FIG. 20, an embodiment of the electronic device may be implemented as a smartphone, but the invention is not limited thereto. An embodiment of the electronic device may be a television, a monitor, a laptop computer, or a tablet, for example. Alternatively, the electronic device may be a vehicle or an automobile.

The display device according to embodiments may be applied to a display device included in a computer, a notebook, a mobile phone, a smart phone, a smart pad, a portable media player (PMP), a personal digital assistant (PDA), an MP3 player, or the like.

The invention should not be construed as being limited to the embodiments set forth herein. Rather, these embodiments are provided so that this disclosure will be thorough and complete and will fully convey the concept of the invention to those skilled in the art.

While the invention has been particularly shown and described with reference to embodiments thereof, it will be understood by those of ordinary skill in the art that various changes in form and details may be made therein without departing from the spirit or scope of the invention as defined by the following claims.

What is claimed is:

1. A display device comprising:
a display panel including a pixel;
a gate emission driver which outputs a gate signal and an emission signal to the pixel;
a data driver which applies a data voltage to the display panel; and
a driving controller which controls the gate emission driver and the data driver,
wherein the gate emission driver includes a control gate signal generator which generates a control gate signal and a write gate signal generator which generates a write gate signal,
wherein the pixel includes:
a driving transistor which generates a driving current based on the data voltage;
a write transistor which applies the data voltage to a control electrode of the driving transistor in response to the write gate signal;
an initialization transistor which applies a reference voltage to the control electrode of the driving transistor in response to the control gate signal; and
a light emitting element which emits light based on the driving current,
wherein the write gate signal generator generates the write gate signal based on a carry clock signal and a first clock signal, and
wherein the control gate signal generator generates the control gate signal based on the carry clock signal.

2. The display device of claim 1, wherein the write gate signal generator is connected to a carry clock line which transmits the carry clock signal, and
wherein the control gate signal generator is connected to the carry clock line.

3. The display device of claim 1, wherein the write gate signal generator generates the write gate signals based on the carry clock signal, the first clock signal and a second clock signal,
wherein the write gate signal generator includes:
a write gate signal controller which outputs a carry signal based on the carry clock signal;
a first write gate signal outputter which outputs a first write gate signal based on the carry signal and the first clock signal; and
a second write gate signal outputter which outputs a second write gate signal based on the carry signal and a second clock signal.

4. The display device of claim 3, wherein the display panel includes first to N-th pixel-rows which are sequentially arranged, and
wherein the first write gate signal is applied to the first pixel-row, and the second write gate signal is applied to the second pixel-row.

5. The display device of claim 4, wherein the control gate signal generator outputs the control gate signal to the first pixel-row and the second pixel-row.

6. The display device of claim 1, wherein a frame period in which the display panel is driven includes an address period and a self-scan period,
wherein in the address period, the data voltage is applied to the pixel, and the pixel emits light based on the data voltage,
wherein in the self-scan period, the pixel emits light based on the data voltage of the address period, and
wherein in the self-scan period, the carry clock signal has direct current voltage.

7. The display device of claim 6, wherein in the address period, the write gate signal maintains an inactivation level, and the control gate signal maintains an inactivation level.

8. The display device of claim 1, wherein the pixel includes:
a first transistor including a control electrode connected to a first node, a first electrode connected to a second node and a second electrode connected to a third node;
a second transistor which applies the data voltage to the first node in response to the write gate signal;
a third transistor which applies the reference voltage to the first node in response to the control gate signal;
a fourth transistor which applies a first power voltage to the second node in response to a second emission signal;
a fifth transistor which connects the third node and a fourth node to each other in response to a first emission signal;
a sixth transistor which applies an initialization voltage to the fourth node in response to an initialization gate signal;
a first capacitor including a first electrode connected to the first node and a second electrode connected to the third node; and
a light emitting element including a first electrode connected to the fourth node and a second electrode which receives a second power voltage, and
wherein the first transistor is the driving transistor, the second transistor is the write transistor, and the third transistor is the initialization transistor.

9. The display device of claim 8, wherein the gate emission driver further includes a first emission control signal generator which generates the first emission signal, a second emission control signal generator which generates the second emission signal, and an initialization gate signal generator which generates the initialization gate signal,
wherein the first emission control signal generator generates the first emission signal based on a third clock signal and a fourth clock signal,
wherein the second emission control signal generator generates the second emission signal based on the third clock signal and the fourth clock signal, and
wherein the initialization gate signal generator generates the initialization gate signal based on the third clock signal and the fourth clock signal.

10. The display device of claim 9, wherein the second emission control signal generator includes second-first to second-K-th emission control signal sub-generators,
wherein the initialization gate signal generator includes first to K-th initialization gate signal sub-generators, and
wherein the second-first to second-K-th emission control signal sub-generators and first to K-th initialization gate signal sub-generators are arranged alternately with each other.

11. The display device of claim 10, wherein a write gate line, which transmits the write gate signal, extends in a first direction,
wherein the first initialization gate signal sub-generator is spaced apart from the second-first emission control signal sub-generator in a second direction different from the first direction,
wherein the second-second emission control signal sub-generator is spaced apart from the first initialization gate signal sub-generator in a second direction, and
wherein the second initialization gate signal sub-generator is spaced apart from the second-second emission control signal sub-generator in the second direction.

12. The display device of claim 11, wherein the first emission control signal generator includes first to K-th emission control signal sub-generators, and
wherein the first to K-th emission control signal sub-generators are sequentially arranged in the second direction.

13. The display device of claim 8, wherein the pixel further includes a second capacitor,
wherein the first transistor further includes a second control electrode connected to the third node,
wherein the second transistor includes a control electrode which receives the write gate signal, a first electrode which receives the data voltage and a second electrode connected to the first node,
wherein the third transistor includes a control electrode which receives the control gate signal, a first electrode which receives the reference voltage and a second electrode connected to the first node,
wherein the fourth transistor includes a control electrode which receives the second emission signal, a first electrode which receives the first power voltage and a second electrode connected to the second node,
wherein the fifth transistor includes a control electrode which receives the first emission signal, a first electrode connected to the third node and a second electrode connected to the fourth node,
wherein the sixth transistor includes a control electrode which receives the initialization gate signal, a first electrode which receives the initialization voltage and a second electrode connected to the fourth node, and
wherein the second capacitor includes a first electrode which receives the first power voltage and a second electrode connected to the third node.

14. A display device comprising:
a display panel including a pixel;
a gate emission driver which outputs a gate signal and an emission signal to the pixel;
a data driver which applies a data voltage to the display panel; and
a driving controller which controls the gate emission driver and the data driver,
wherein the pixel includes:
a first transistor including a control electrode connected to a first node, a first electrode connected to a second node and a second electrode connected to a third node;
a second transistor which applies the data voltage to the first node in response to a write gate signal;
a third transistor which applies a reference voltage to the first node in response to a control gate signal;
a fourth transistor which applies a first power voltage to the second node in response to a second emission signal;
a fifth transistor which connects the third node and a fourth node to each other in response to a first emission signal;
a sixth transistor which applies an initialization voltage to the fourth node in response to an initialization gate signal;
a first capacitor including a first electrode connected to the first node and a second electrode connected to the third node; and
a light emitting element including a first electrode connected to the fourth node and a second electrode which receives a second power voltage, and
wherein the gate emission driver includes:
a first emission control signal generator which generates the first emission signal based on a first clock signal and a second clock signal;
a control gate signal generator which generates the control gate signal based on the first clock signal and the second clock signal;
a second emission control signal generator which generates the second emission signal based on a first clock signal and a second clock signal; and
an initialization gate signal generator which generates the initialization gate signal based on the first clock signal and the second clock signal.

15. The display device of claim 14, wherein a write gate line, which transmits the write gate signal, extends in a first direction,
wherein the initialization gate signal generator is spaced apart from the second emission control signal generator in a second direction different from the first direction, and
wherein the control gate signal generator is spaced apart from the first emission control signal generator in the second direction.

16. The display device of claim 14, wherein the display panel includes first to N-th pixel-rows which are sequentially located,
wherein the write gate signal includes first to N-th write gate signals,
wherein the first write gate signal is applied to the first pixel-row, the second write gate signal is applied to the second pixel-row, the third write gate signal is applied to the third pixel-row, and the fourth write gate signal is applied to the fourth pixel-row,
wherein a timing of the first emission signal applied to the first pixel-row is consistent with a timing of the first emission signal applied to the second pixel-row,
wherein a timing of the first emission signal applied to the third pixel-row is consistent with a timing of the first emission signal applied to the fourth pixel-row, and
wherein the timing of the first emission signal applied to the first pixel-row is inconsistent with the timing of the first emission signal applied to the third pixel-row.

17. The display device of claim 14, wherein the display panel includes first to N-th pixel-rows which are sequentially arranged,
wherein the write gate signal includes first to N-th write gate signals,
wherein the first signal includes first-first to fisrt-K-th emission signals,
wherein the second signal includes first-first to second-K-th emission signals,
wherein the control gate signal includes first to K-th control gate signals,
wherein the initialization gate signal includes first to K-th initialization gate signals,
wherein the first write gate signal is applied to the first pixel-row, and the second write gate signal is applied to the second pixel-row, and
wherein the first-first emission signal, the second-first emission signal, the first control gate signal and the first initialization gate signal are applied to the first pixel-row and the second pixel-row.

18. An electronic device comprising:
a display panel including a pixel;
a gate emission driver which outputs a gate signal and an emission signal to the pixel;
a data driver which applies a data voltage to the display panel;
a driving controller which controls the gate emission driver and the data driver based on an input control signal; and
a processor which outputs the input control signal to the driving controller,
wherein the gate emission driver includes a control gate signal generator which generates a control gate signal and a write gate signal generator which generates a write gate signal,
wherein the pixel includes:
a driving transistor which generates a driving current based on the data voltage;
a write transistor which applies the data voltage to a control electrode of the driving transistor in response to the write gate signal;
an initialization transistor which applies a reference voltage to the control electrode of the driving transistor in response to the control gate signal; and
a light emitting element which emits light based on the driving current,
wherein the write gate signal generator generates the write gate signal based on a carry clock signal and a first clock signal, and
wherein the control gate signal generator generates the control gate signal based on the carry clock signal.

19. The electronic device of claim 18, wherein the write gate signal generator is connected to a carry clock line which transmits the carry clock signal, and
wherein the control gate signal generator is connected to the carry clock line.

20. The electronic device of claim 19, wherein the write gate signal generator generates the write gate signals based on the carry clock signal, the first clock signal and a second clock signal,
wherein the write gate signal generator includes:
a write gate signal controller which outputs a carry signal based on the carry clock signal;
a first write gate signal outputter which outputs a first write gate signal based on the carry signal and the first clock signal; and
a second write gate signal outputter which outputs a second write gate signal based on the carry signal and a second clock signal.
